(19) United States
(12) Patent Application Publication
(10) Pub. No.: US 2016/0021159 A1
(43) Pub. Date: Jan. 21, 2016

(54) SYNCHRONIZATION OF EXPOSITION DATA AND GENERATION OF CUSTOMIZED COMMUNICATIONS AND REPORTS

(71) Applicant: Norman Robert Gritsch, Newport Beach, CA (US)

(72) Inventor: Norman Robert Gritsch, Newport Beach, CA (US)

(21) Appl. No.: 14/332,190

(22) Filed: Jul. 15, 2014

(51) Int. Cl. H04L 29/06; G06F 17/30

(52) U.S. Cl. CPC H04L 65/60; G06F 17/30289

(57) ABSTRACT

Features are disclosed for aggregating data from numerous data sources related to events (such as expositions, trade shows, conventions and meetings) and integrating such data into a comprehensive data store. The data can be analyzed, searched and filtered to provide targeted communications and customized reports regarding various aspects of an exposition or other event. The targeted communications and customized reports may be based on data from multiple (e.g., two or more) discrete data sources. Examples of the targeted communications include text messages, emails, invitations, previews, and follow-up messages designed to facilitate in-person meetings between event participants (e.g., attendees and exhibitors at expositions). Examples of the customized reports include hotel utilization reports to determine the economic impact of an exposition on a host city, commissions due to third-party vendors, and the like.

### BACKGROUND

Expositions—such as trade shows, conferences and conventions—have existed for many years with the objective of bringing together exhibitors offering products, services and information to interested individual attendees in a physical exposition environment. To attract attendees, exhibitors have employed various forms of physical advertisement ranging from pop-up booths to elaborate presentation platforms that can be assembled and disassembled rapidly to meet the limited exposition schedule. The end goal of a successful exposition is to have desired exhibitors and attendees meet to conduct business.

In support of this goal, exposition sponsors have also attempted to bring the right attendees to their expositions through various forms of marketing and advertising in written and electronic form. Similarly, exposition sponsors market their exposition to exhibitors based upon the quality and purchasing needs of exposition attendees. Once an attendee arrives at the exposition they are typically provided a registration badge or other form of identification that may help present themselves to exhibitors. To encourage meetings between exhibitors and attendees, exposition sponsors have developed and adopted all sorts of separate information sources such as printed directories, printed and electronic tradeshow floor maps, exposition “apps” that include information on exhibitors and events, broadcast emails and banner advertisements.

To further encourage exhibitors and attendees to come to their expositions, sponsors typically book blocks of desired hotel rooms, coordinate special events, and provide “sponsorship” opportunities for exhibitors. Sponsors hire various third party service providers to assist with the development and presentation of the exposition, and each such provider creates a set of data related to the exposition that is separate from the sponsor's own set of data.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1A is a block diagram of example data and system components according to some embodiments.

FIG. 1B is a block diagram of an example exposition synchronization system, data sources, and user devices according to some embodiments.

FIG. 2A is a flow diagram of an illustrative process for generating a targeted email to an attendee before an exposition.

FIG. 2B illustrates an example targeted email generated using the process outlined in FIG. 2A.

FIG. 3A is a flow diagram of an illustrative process for generating a targeted coupon for an attendee.

FIG. 3B illustrates an example targeted coupon generated using the process outlined in FIG. 3A.

FIG. 4A is a flow diagram of an illustrative process for generating a targeted text message or email to an attendee upon arriving at an exposition.

FIG. 4B illustrates an example targeted text message or email generated using the process outlined in FIG. 4A.

FIG. 5A is a flow diagram of an illustrative process for generating a targeted exhibitor preview email to an attendee before an exposition.

FIG. 5B illustrates an example targeted exhibitor preview email generated using the process outlined in FIG. 5A.

FIG. 6A is a flow diagram of an illustrative process for generating a targeted special event invitation to an attendee at an exposition.

FIG. 6B illustrates an example targeted special event invitation generated using the process outlined in FIG. 6A.

FIG. 7A is a flow diagram of an illustrative process for generating a targeted bus transportation coordination email or text message to an attendee at an exposition.

FIG. 7B illustrates an example targeted bus transportation coordination email sent to the transportation company generated using the process outlined in FIG. 7A.

FIG. 7C illustrates an example targeted bus transportation coordination text message sent to event participants generated using the process outlined in FIG. 7A.

FIG. 8A is a flow diagram of an illustrative process for generating hotel utilization reports for an exposition.

FIG. 8B illustrates an example hotel utilization report for a specific hotel generated using the process outlined in FIG. 8A.

FIG. 8C illustrates an example hotel utilization report for all individuals attending an exposition generated using the process outlined in FIG. 8A.

### DETAILED DESCRIPTION OF ILLUSTRATIVE EMBODIMENTS

### Introduction

The present disclosure is directed to facilitating targeted contact between exhibitors and attendees at expositions. The disclosure involves a process in which data from multiple, disparate data sources is aggregated and integrated or otherwise synchronized to generate unique targeted communications and/or reports. The targeted communications and reports may include data from each of the disparate data sources or some subset thereof, such that generation of the communications and reports would not be possible without first aggregating data from the various data sources, integrating or synchronizing such data and, in some cases, performing additional processing to the data.

As used herein, the term “exposition” should be broadly construed and includes trade shows, conferences, conventions, and similar events which involve the gathering of numerous people to share and present products, services, information or a combination thereof. The term “sponsor” should also be broadly construed and includes the person, business, association or entity that sponsors, owns, controls or coordinates an exposition. The term “exhibitor” should also be broadly construed to include companies or individuals presenting their products, services or information at an exposition. The term “attendee” should also be broadly construed and includes individuals who are interested in, are being invited to attend, or are attending an exposition.

Conventionally, sponsors are limited to offering exhibitors a physical exposition location to attract attendees. Exhibitors thus rely primarily on their physical presence at expositions to attract attendees. The exhibitors must then determine whether individual attendees are desired contacts. Attendees typically must review the entire exposition, usually by walking, to find those exhibitors that may present attractive offerings. This process is time-consuming and inefficient for all involved and makes the exposition less valuable for participants and less valuable as a business. In addition, exposition sponsors typically do not have access to synchronized real-time data related to exposition participants (e.g., exhibitors and attendees), their whereabouts, their interactions, and the like. The sponsors are therefore unable to generate or otherwise facilitate targeted communications or reports based on the synchronized data.

Some aspects of the present will improve the interaction between exhibitors and attendees through the aggregation of data from multiple (e.g., two or more) disparate data sources, the integration of such data, and the generation of targeted communications using the data. The data sources may include sources managed or otherwise under the control of separate entities or under separate unconnected systems. In some embodiments, a system may obtain data regarding expositions, exhibitors, attendees, housing, attendance, travel, replies and other user-provided information, etc. Each of these types of data (or subsets thereof) may be obtained from different data sources, physically located in different locations, collected by and under the control of different entities, etc. By obtaining and integrating the data from the various data sources, targeted communications and reports can be generated that would not otherwise be possible using only data from one of the data sources. For example, data collected and managed by exposition sponsors regarding the various exhibitors and attendees of an exposition can be obtained from one or more data sources under the control of the exposition sponsor. The sponsor may have different computer systems to manage exhibitor registration data and exhibition hall floorplan mapping. In addition, the sponsor may have outsourced management of housing and/or onsite registration for the attendees and exhibitors to separate housing and registration providers. In this case, neither the sponsor nor any other entity would be able to generate communications targeted at attendees staying at particular hotels when they arrive at the exposition. However, once attendee, housing, and registration data has been aggregated and integrated, the sponsor or some other authorized entity (e.g., an exhibitor) can generate communications targeting attendees staying at particular hotels. Such communications may be further targeted at attendees with specific interests or characteristics (e.g., attendees with specific demographic characteristics who are interested in specific products or services being exhibited at the exposition), which would not be possible using the housing data alone. The timing of the delivery of such communications can also be tied to the time of arrival at the exposition.

Additional aspects of the present disclosure relate to illustrative communications that can be generated using exposition-related data aggregated and integrated from separate data sources. As compared to conventional systems that provide for email advertisement to all attendees, in some embodiments, a sponsor can provide targeted informational emails and other messages to certain targeted attendees on behalf of certain exhibitors. For example, messages can be generated to provide information about a particular exhibitor to each attendee that meets certain criteria, such as attendees that have indicated an interest in goods or services provided by the exhibitor, attendees who are based in geographic areas desirable to the exhibitor, etc. As another example, messages can be generated to invite particular attendees to a particular exhibitor's booth upon detecting that the attendees have entered the exposition center. As a further example, messages can be generated for delivery to attendees at particular housing locations, such as invitations to a hospitality suite managed by a particular exhibitor. As a still further example, messages can be generated to provide transportation information to particular attendees, such as the location of transportation to an off-site event when the location of transportation differs depending upon where the attendees are staying. These and other messages can be generated using the aggregated and integrated data described above and in greater detail below by applying filters using criteria associated with data from multiple data sources.

Further aspects of the present disclosure relate to illustrative reports that can be generated using exposition-related data aggregated from separate data sources. In some embodiments, hotel utilization reports can be generated to show a combination and comparison of hotel data provided by a hotel and also by a third party housing reservation service or otherwise maintained by the sponsor, along with additional data provided by attendees. The report can be used to compare the actual utilization of hotel rooms attributable to the exposition with the utilization reported by the hotels themselves. Such information can be useful to determine the hotel reservation commission due and the compliance with hotel “attrition clauses” by the exposition sponsor. These and other reports can also be useful in analyzing the economic impact that an exposition has on the geographic region in which the exposition takes place.

Although aspects of the embodiments described in the disclosure will focus, for the purpose of illustration, on aggregating data, integrating data, and generating communications and reports for expositions, one skilled in the art will appreciate that the techniques disclosed herein may be applied to any number of services, processes, or applications. Data regarding other types of events and scenarios may be aggregated and used to generate targeted communications and reports, and to facilitate interactions between interested parties. For example, the systems and methods described herein can be used to facilitate contacts between colleges and prospective students, manage sports tournaments, etc. Various aspects of the disclosure will now be described with regard to certain examples and embodiments, which are intended to illustrate but not limit the disclosure.

### Networked Data Aggregation, Integration, Messaging, and Reporting Environment

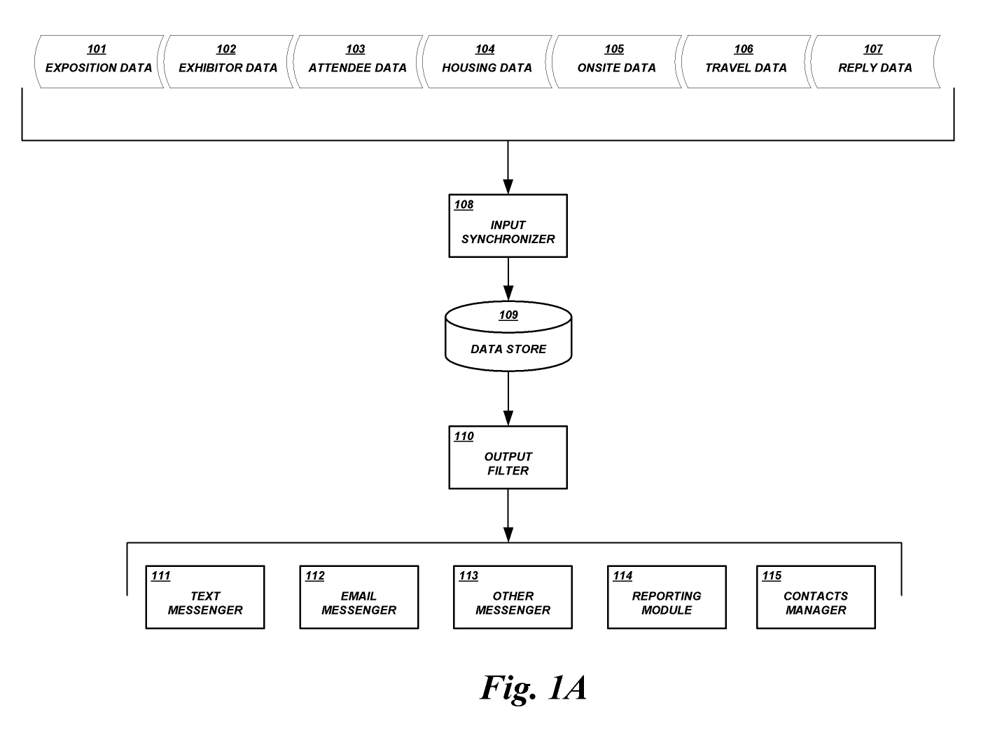

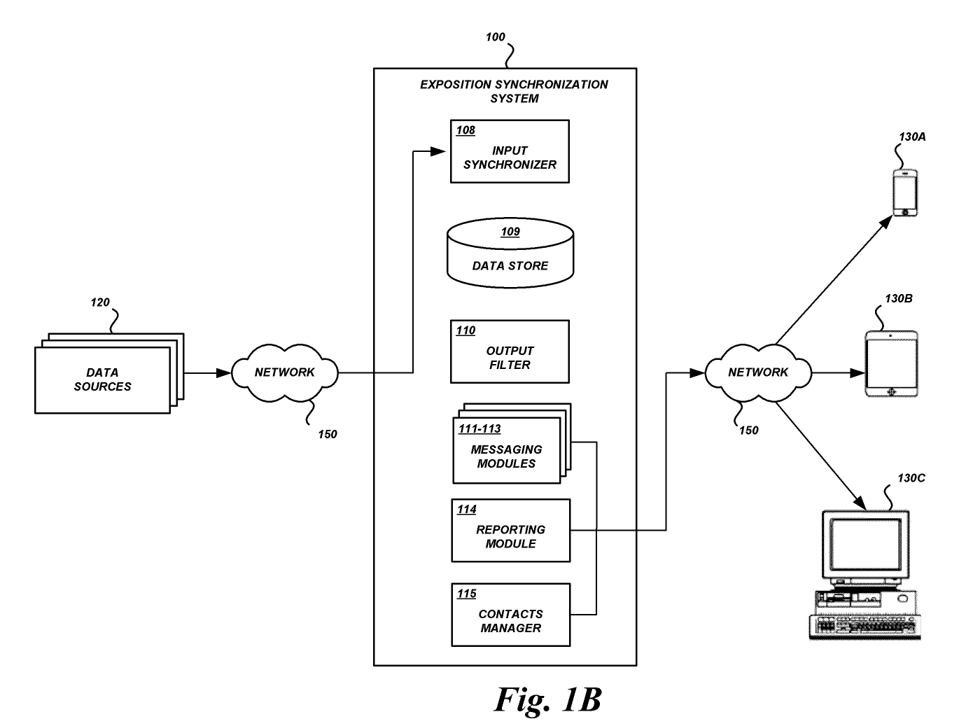

FIG. 1A illustrates various types of information obtained from multiple data sources, and also system components that may aggregate, integrate, and use the information to generate targeted communications, reports, and the like. During the planning and operation of an exposition, there are numerous types of information and data that are created or developed. The first type of information is related to the exposition and its sponsor. A sponsor may establish and define a specific exposition through exposition data 101. The sponsor can define the purpose, location, date, timing and events of the exposition through the creation or maintenance of exposition data 101. Sponsors may define the specific data elements or use third party service providers (such as the exposition venue owner, event planners, exposition managers, exposition floor mapping companies, etc.) to assist in the development of the exposition. The exposition data may include, but is not limited to:
1. Sponsor name
2. Sponsor address and other contact information
3. Sponsor goals and objectives
4. Sponsor membership list, demographic data and contact information
5. Exposition name and purpose
6. Exposition location and dates
7. Exposition events, locations and schedules
8. Exposition map and physical layout
9. Exhibitor locations within the exposition
10. Exhibitor categories, products and services

The exhibitors at the exposition can also supply or create data related to the products, services or information that they will offer to attendees. For example, exhibitors can provide data about their business and their product or service offerings via a registration form or web site. This exhibitor data 102 could be supplied to the exposition synchronization system 100 by the sponsor, but may also be created through other third parties such as exposition managers, exhibitors, registration service providers and other similar service providers. The exhibitor data may include, but is not limited to:
1. Exhibitor name, address and other contact information
2. Exhibitor product, service and information offerings
3. Exhibitor web site
4. Exhibitor meeting schedule and availability
5. Exhibitor client list
6. Exhibitor desired attendee contacts by name, company, demographics and/or interests
7. Exhibitor product samples or information

The attendees of an exposition can also supply or create data related to themselves, along with the products, services or information that are of interest to them at the exposition. For example, attendees can provide data about their business and their product or service interests via a registration form or web site. This attendee data 103 could be supplied by the sponsor or attendees, but may also be created through other third parties such as exposition managers, registration service providers and other similar service providers. The attendee data may include, but is not limited to:
1. Attendee name, business, address and other contact information
2. Attendee email address and cell phone number
3. Attendee company, title and demographic information
4. Attendee desired list of exhibitor contacts by name, product type, service or information presented
5. Attendee history with the sponsor and prior exposition attendance
6. Attendee travel plans to exposition
7. Attendee hotel or other housing plans at exposition

Providing hotel rooms or other housing for attendees is frequently an important component to a successful exposition. Sponsors may arrange for “room blocks” reserved at selected hotels, while others use software systems and services offered by third-party service providers. Frequently, the hotel contracts that allow a sponsor to control the reservations over a room block also include an “attrition clause” requiring the sponsor to pay for rooms that are not utilized. Whichever method (or combination thereof) is selected by the sponsor, the end result is housing data 104 regarding where attendees plan to stay while attending the exposition. Housing data 104 may be supplied by the sponsor, exhibitors or attendees, but may also be created through other third parties such as hotels, travel agents, hotel reservation service providers and other similar service providers. The housing data 104 may include, but is not limited to:
1. Hotel rooms booked for attendees, exhibitors and staff
2. Hotel name, address and contact information
3. Check in date
4. Check out date
5. Room rates

Controlling admission and tracking attendance is frequently an important component of a successful exposition. Some sponsors track this information using their own computing resources, while others use software systems and services offered by third-party service providers. Whichever method (or a combination thereof) is selected by the sponsor, the end result is a set of onsite data 105 regarding the physical presence and interaction of attendees and exhibitors at the exposition. The onsite data 105 may be supplied by the sponsor, but may also be created through wireless communication devices (e.g., barcode scanners, RFID devices, etc.), networked computer devices associated with other third parties such as reservation service providers and other similar services, and the like. The onsite data 105 may include, but is not limited to:
1. Date, time and place of each individual's entry to the exposition (or events)
2. Date, time and place of each individual's exit from the exposition (or events)
3.Date, time, and exhibitor of each demonstration that each individual attended
4. Date, time, and exhibitors with whom each individual met
5. Date, time, and location or movement within the exposition center of each individual

Travelling to an exposition is also an important component to a successful exposition. Some sponsors track this information using their own computing resources, while others use software systems and services offered by third-party service providers. Whichever method (or combination thereof) is selected by the sponsor, the end result is a set of travel data 106 regarding when and how individuals plan to travel to the exposition. The travel data 106 may be supplied by the sponsor, exhibitors or attendees, but may also be created through other third parties such as airlines, travel agents, travel service providers and other similar services. The travel data may include, but is not limited to:
1. Departure city, location, date and time
2. Arrival city, location, date and time
3. Return city, location, date and time

Utilizing the exposition synchronization system, individuals attending the exposition may be asked to reply with additional information concerning their participation in the exposition (reply data 107). For example, attendees can be prompted (e.g., via a confirmation email and a link to a questionnaire or other data entry form) to provide or confirm information about their exposition-related interests, travel, lodging, and contact information. In this way, the exposition synchronization system can receive reply data 107 that may not be available via any other data source (e.g., hotel information for attendees that do not choose to use one of the reserved “room blocks”). In some embodiments, attendees may be offered special incentives to provide such information. For example, attendees can be given the opportunity to participate in special events if the attendees agree to provide the requested information, such as their mobile phone number. Reply data 107 can be integrated into the data store 109 through the input synchronizer 108.

While each of these data sets exists for most expositions, conventional systems do not provide sponsors with real-time access to all of the above-referenced data sets through a synchronized computer data store and system that can generate communications with selected exhibitors and attendees to facilitate their efficient and direct contact at the exposition, generate reports, and the like.

As shown in FIG. 1A, the various types of exposition-related data 101-107 can be loaded via an input synchronizer 108 into a data store 109. In some embodiments, the input synchronizer 108 may connect to various external data sources 120 to obtain data, as shown in FIG. 1B and described in greater detail below. For example, the input synchronizer 108 may be implemented on a computing system with network access to various data providers, such as a data source managed by a sponsor, a separate data source managed by an exhibitor registration provider, another data source managed by an attendee registration provider, another source managed by an onsite attendance provider, yet another data source managed by a lodging and/or travel provider, etc.

The data 101-107 may be stored at the respective data sources 120 in various formats, such as in relational databases, object-oriented databases, data catalogs, spreadsheets, markup documents (e.g., extensible markup language or “XML” documents), and the like. The data can be obtained from the data sources 120 on-demand (e.g., upon request of a system administrator of one or more of the data sources 120), according to some predetermined or dynamically determined schedule (e.g., hourly, daily, weekly, etc.), or in response to some other event (e.g., upon change of data at the data source an update may be sent to the exposition synchronization system 100).

The input synchronizer 108 may perform various operations on the data prior or subsequent to storing the data in the data store 109. In some embodiments, the input synchronizer 108 may perform duplicate checking and removal, indexing, cross-referencing, calculation or other generation of new data, format conversion or standardization, etc.

The data 101-107 obtained and processed by the input synchronizer 108 may be stored in the data store 109 in any desired format. For example, data may be stored in relational databases, object-oriented databases, data catalogs, spreadsheets, markup documents, links to other documents, websites or programs, some combination thereof, etc. The data store 109 may store data in a secure fashion using, e.g., encryption, security permissions, some combination thereof, etc. Access to the data store 109 may also be controlled and limited to certain users and having limited access permissions.

In some embodiments, data may be entered directly into the data store 109 without being retrieved by the input synchronizer 108. For example, a system administrator or some other user may define an exposition by submitting data directly to the data store 109 or through the input synchronizer 108, without the data coming from a separate external data source 120. As another example, administrators may add or update data in the data store 109 over the course of an exposition in order to correct identified inaccuracies, provide additional features, etc.

The output filter 110 can allow authorized users (e.g., sponsor representatives, system administrators, and/or other authorized users) to access data in the data store 109 to generate targeted communications or reports. Users can select particular types of data (e.g., attendee data 103, exhibitor data 102), specific pieces of data (e.g., attendee names, exhibitor products), and the like using customizable criteria. For example, a user may wish to generate a targeted communication to particular attendees on behalf of a particular exhibitor. The user can select the data using various search criteria, Boolean logic, and the like in order to filter the attendees and obtain the desired data about those attendees. The data can then be used to generate the targeted messages, as described in greater detail below.

One or more messaging modules may be used to send targeted communications. The messaging modules may include a text messenger 111 configured to generate text messages deliverable to mobile phones, an email messenger 112 configured to deliver email messages to particular email addresses, and various other messengers 113. The other messengers 113 may be used to automatically send other types of electronic messages, such as social media messages and postings (e.g., Facebook), blog or microblog postings (e.g., Twitter), or the like. Other messengers 113 may also be used to generate personalized printed messages, such as exposition admission passes, registration badges, event tickets, and event invitations that can be emailed, mailed or hand-delivered to recipients. The other messenger 113 could also be used to transmit data to other electronic communication platforms or “apps” that may be used in connection with an exposition. Various examples of targeted communications are described in greater detail below. The reporting module 114 can be used to create customized reports based upon and utilizing the desired data elements obtained from the output filter 110. Various examples of reports are described in greater detail below.

The contacts manager 114 can be used to facilitate the matching of exhibitors and attendees based upon the characteristics of the exhibitors (e.g., products, services, information, etc.) and the attendees (e.g., demographics, products needed, etc.). After initial matching by the system, the contacts manager 114 allows attendees to indicate those exhibitors from which they would like additional information or contact. This reply data 108 could then be utilized by the system to generate additional targeted communications, including text messages, email messages or other messages. Thus, the contacts manager 114 may enable exhibitors and attendees to establish contact before, during or after the exposition.

FIG. 1B shows an example network environment in which features of the present disclosure can be implemented. The network environment may include an exposition synchronization system 100, various data sources 120 to provide data for use by the exposition synchronization system 100, and various user devices 130A-130C to receive communications and data from the exposition synchronization system 100. The system may receive data from all types of data sources 120, including but not limited to server computing devices storing the various types of data 101-107 illustrated in FIG. 1A, other computing and mobile devices, bar code readers and other scanners used at the exposition center to monitor the attendance of the attendees, radio-frequency identification devices (“RFID”) and other location establishing devices used to monitor the movements of the attendees within the exposition center, etc.

The various devices shown in FIG. 1B may communicate with each other via one or more communication networks 150. A communication network 150 may be a publicly accessible network of linked networks, possibly operated by various distinct parties, such as the Internet. In other embodiments, the network 150 may include a private network, personal area network, local area network, wide area network, cable network, satellite network, cellular telephone network, etc. or combination thereof, each with access to and/or from the Internet.

The exposition synchronization system 100 can be a computing system configured to receive, process, and maintain exposition-related data (such as the data 101-107 illustrated in FIG. 1A) from various data sources 120, and generate targeted communications and reports for delivery to user devices 130A-130C. For example, the exposition synchronization system 100 can be a server or group of servers that may be accessed via a network 150. The exposition synchronization system 100 can include a number of components to provide various features, such as the input synchronizer 108, data store 109, output filter 110, messaging modules 111-113, reporting module 114, and contacts manager 115, as described above with respect to FIG. 1A.

The exposition synchronization system 100 may be a single computing device, or it may include multiple distinct computing devices, such as computer servers, logically or physically grouped together to collectively operate as a server. The components of the exposition synchronization system 100 can each be implemented as hardware, such as a server computing device, or as a combination of hardware and software. In addition, the components of exposition synchronization system 100 can be combined on one server computing device or separated individually or into groups on several server computing devices. In some embodiments, the exposition synchronization system 100 may include additional or fewer components than illustrated in FIG. 1B. Data for the various expositions included in the exposition synchronization system 100 may also be segregated to create data confidentiality and security.

In some embodiments, the features and services provided by the exposition synchronization system 100 may be implemented as web services accessible via the communication network 150. In further embodiments, the exposition synchronization system 100 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

The user devices 130 can correspond to a wide variety of computing devices designed to receive data from the exposition synchronization system 100, including mobile phones, tablet computing devices, media players, wearable computing devices (e.g., smart watches, smart eyewear, etc.), and various other mobile or personal electronic devices and appliances. Some user devices 130 may be configured with browser applications to communicate via the network 150 with other computing systems, such the exposition synchronization system 100, and to receive, process, and display reports, targeted communications, and the like. The user devices 130 may also be configured with various communications interfaces and components that provide text message, email and other messaging functionality.

### Example Targeted Communications

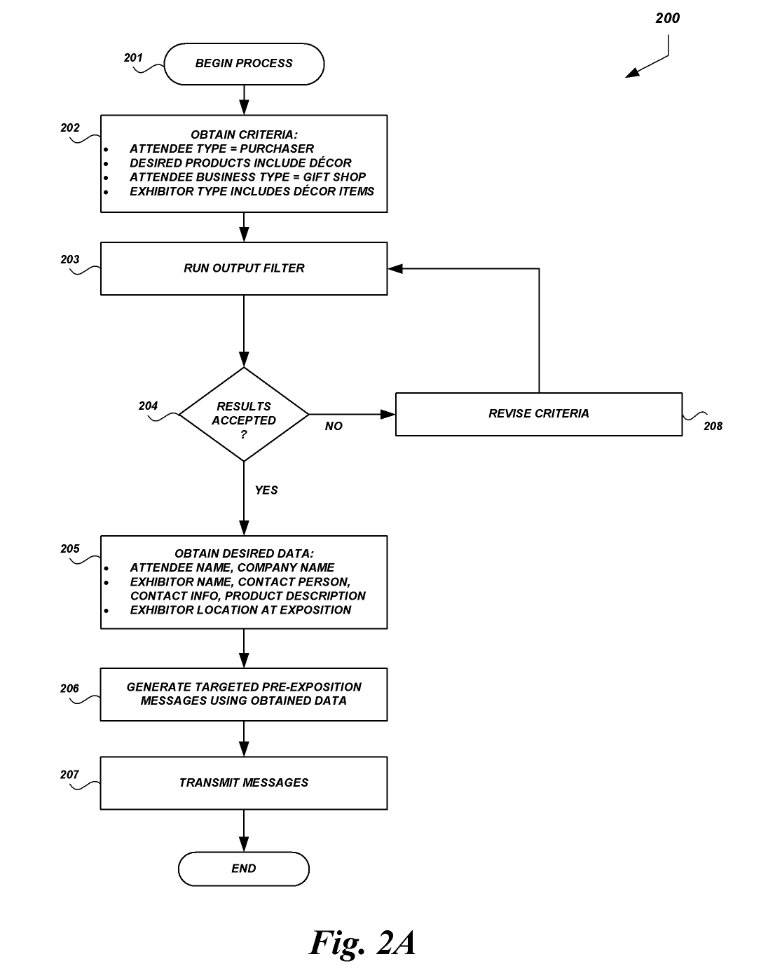

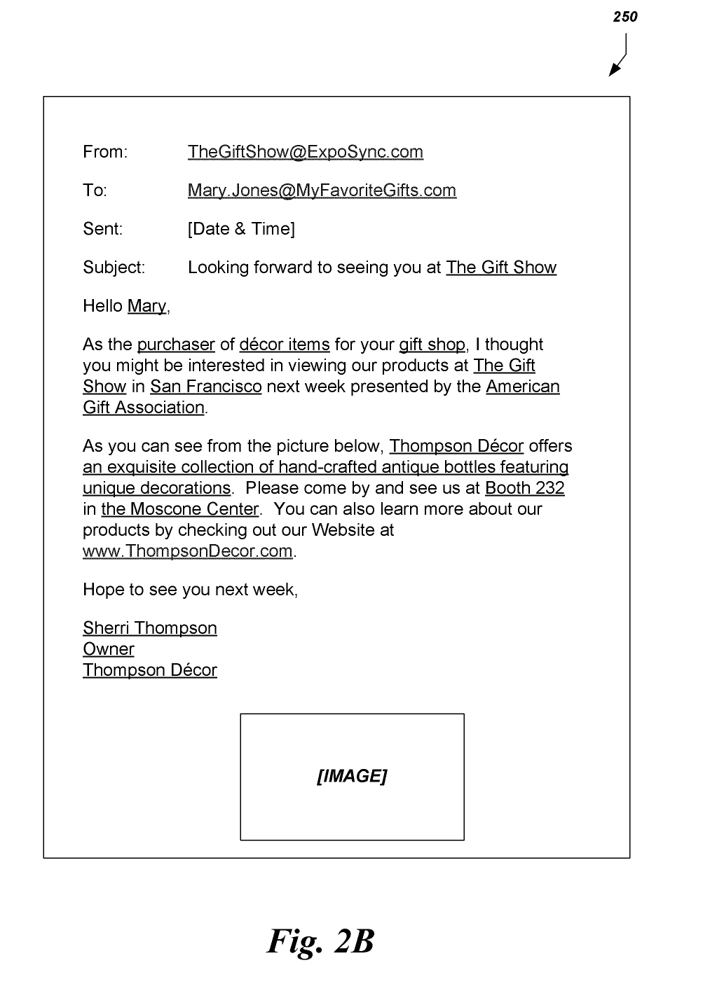

FIG. 2A presents an example process 200 for generating a targeted communication using various types of exposition-related data 101-107 aggregated and integrated from multiple (e.g., two or more) different data sources 120. An example of a targeted communication generated using the process 200 is shown in FIG. 2B. Illustratively, the targeted communication is a customized email to a particular attendee (e.g., Mary Jones) of an exposition (e.g., The Gift Show in San Francisco) inviting the attendee to preview the products that will be offered by an exhibitor (e.g., Thompson Décor) because the attendee has indicated that she is attending the exposition to purchase décor items for her gift shop. In this example, the exposition synchronization system 100 has knowledge of the type of products that the exhibitor provides because the exposition synchronization system 100 has received the exhibitor data 102 (products offered, etc.) and exposition data 101 (exhibitor location, contact information, etc.) ahead of time. Thus, the exposition synchronization system 100 can automatically perform the process 200 to generate email messages for the exhibitors (or some subset thereof) without any further interaction required from the exhibitors.

The process 200 begins at block 201. The process 200 involves searching and retrieving data from the data store 109 after the input synchronizer 108 has obtained the data from the various data sources 120. In this example, the data store 109 may include 25,000 individuals.

At block 202, an authorized user of the exposition synchronization system 100 can provide the desired search criteria in order to obtain a filtered list of attendees that meet the desired criteria. For example, the user may access the exposition synchronization system 100 on behalf of an exhibitor specializing in the sale of décor products to retailers. The user can access an interface (the output filter 110) to limit the search to attendees that are “purchasers” of “décor” products for “gift shops”. At the same time, the filter for exhibitors is limited to those that are offering “décor items” at the exposition.

At block 203, the output filter 110 can apply the criteria provided above to generate search results. In the current example, the thousands of individuals and companies that are included in the data store 109 as attendees and/or exhibitors are filtered down to a list of only those attendees coming to the exposition to purchase gifts in the décor category and those exhibitors that will offer products within the same category. Illustratively, the output filter 110 reduces the list to 125 individual attendees who meet the filter criteria.

At decision block 204, the authorized user can review the results of the search to determine if the results are acceptable If yes, the process 200 proceeds to block 205; otherwise, the process 200 proceeds to block 208 to revise the search criteria used by the output filter 110.

At block 205, the particular data elements to be used in the targeted communication are obtained. In the present example, the user selected the fields for (i) attendee's name, company name, email address, (ii) the exhibitor's products description, (iii) location at the exposition, (iv) exhibitor contact information and (v) exhibitor product photo.

At block 206, the appropriate messaging module 111-113 can generate the targeted message(s) using the data obtained above. In the present example, the email messenger 112 incorporates the desired data into a targeted message template.

At block 207, the message(s) can be transmitted. In the present example, the email messenger 112 sends out the emails.

FIG. 2B is an example targeted email message 250. The message 250 may be based on a selected or automatically determined template, and includes the following data elements (indicated by underlined text) inserted into the template:

Exposition Data:
Sponsor Name (American Gift Association)
Exposition Name (The Gift Show)
Exposition City (San Francisco)
Exposition Venue (Moscone Center)
Exhibitor Location at Exposition (Booth 232)

Exhibitor Data:
Exhibitor Products Offered (décor items)
Exhibitor Name (Thompson Décor)
Exhibitor Product Description (an exquisite . . . decorations)
Exhibitor Contact Person Name (Sherri Thompson)
Exhibitor Contact Person Title (Owner)
Exhibitor Website (www.ThompsonDecor.com)
Exhibitor Product Photo

Attendee Data:
Attendee Title/Role (purchaser)
Attendee Business Type (gift shop)
Attendee Products Desired (décor items)
Attendee Email Address (Mary.Jones@MyFavoriteGifts.com)
Attendee First Name (Mary)

Advantageously, the process 200 allows sponsors to facilitate the introduction of exhibitors and attendees based upon their products offered and desired. Based upon data elements filtered from the exposition data 101, exhibitor data 102, and attendee data 103, a targeted email can be sent to an attendee inviting them to visit the exhibitor at the exposition. Conventional systems only permit the creation of broadcast emails where all attendees receive the same promotional email or advertisement, without regard for their needs or product interests. This type of targeted email is difficult or impossible to create using conventional systems. In those cases, the exhibitor's primary opportunity to communicate with the desired attendee is generally limited to the physical marketplace offered by the exposition. The attendee generally does not have the opportunity to preview the products offered by the exhibitor to determine if the products may be a desired fit for her purchasing needs.

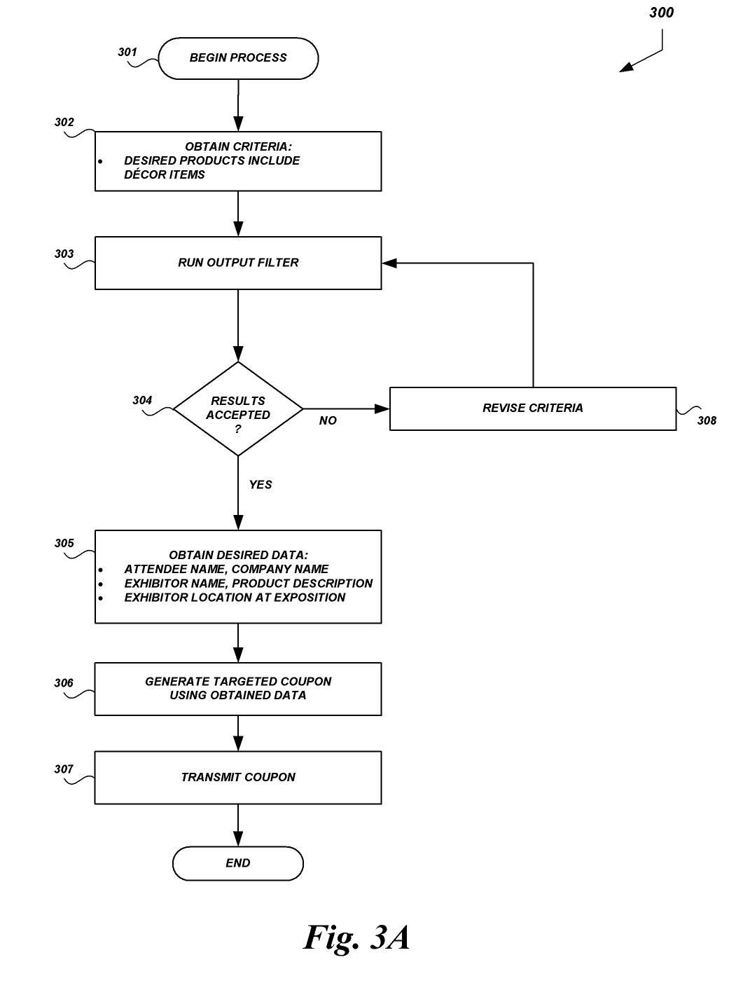

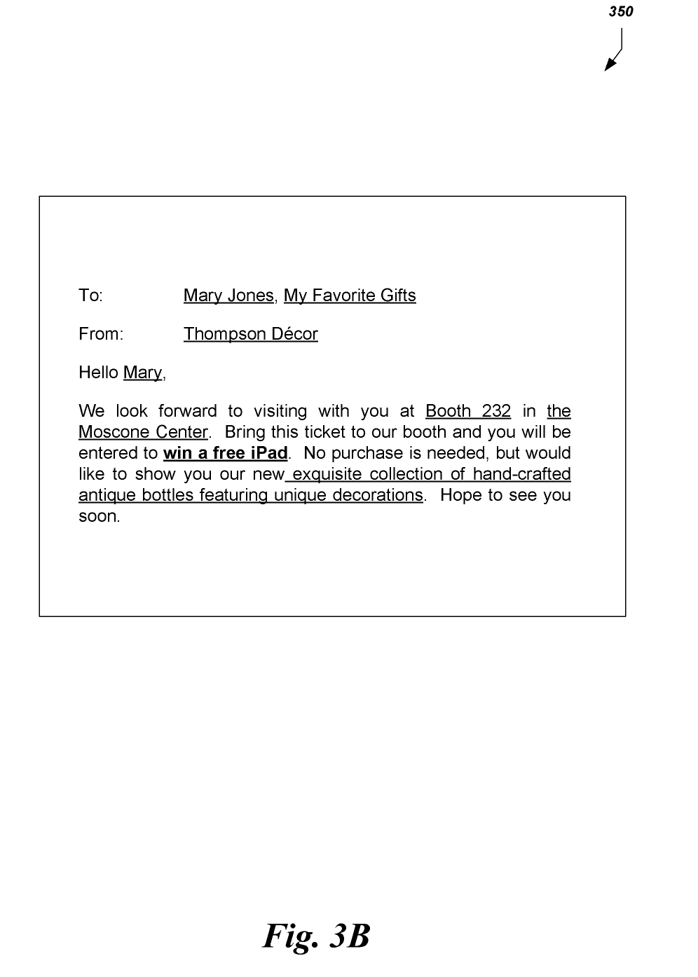

FIG. 3A presents an example process 300 for generating a targeted coupon or invitation using various types of exposition-related data 101-107 aggregated and integrated from multiple (e.g., two or more) different data sources 120. An example of a targeted coupon generated using the process 300 is shown in FIG. 3B. Illustratively, the targeted communication is a customized coupon to a particular attendee (e.g., Mary Jones) of an exposition (e.g., The Gift Show in San Francisco) inviting the attendee to visit a particular exhibitor's booth (Thompson Décor) and to enter a raffle to win a prize.

The process 300 begins at block 301. The process 300 involves searching and retrieving data from the data store 109 after the input synchronizer 108 has obtained the data from the various data sources 120. As with the prior example, the data store 109 may include 25,000 individuals.

At block 302, an authorized user of the exposition synchronization system 100 can provide the desired search criteria in order to obtain a filtered list of attendees that meet the desired criteria. For example, the authorized user can limit the search to attendees seeking “décor items”.

At block 303, the output filter 110 can apply the criteria provided above to generate search results. In the current example, the thousands of individuals that are included in the data store 109 as attendees are filtered down to a list of only those attendees coming to the exposition to purchase gifts in the décor category. Because this search is not limited to “purchasers” or “gift shops” the list of attendees may be larger than the list from FIG. 2A. Illustratively, the output filter 110 in the present example may produce a list of 300 individuals who meet the filter criteria of the 25,000 individuals in the data store 109.

At decision block 304, the authorized user can review the results of the search to determine if the results are acceptable. If yes, the process 300 proceeds to block 305; otherwise, the process 300 proceeds to block 308 to revise the search criteria used by the output filter 110.

At block 305, the particular data elements to be used in the targeted communication are obtained. In the present example, the user selected the fields for (i) the exhibitor's products description and (ii) location at the exposition.

At block 306, the appropriate messaging module 111-113 can generate the targeted coupon(s) using the data obtained above. In the present example, the other messenger 113 incorporates the desired data into a targeted message template. For example, the message may be a print-out that is to be provided to the attendee upon checking in at the exposition center. Alternatively, the attendee could receive the coupon prior to the exposition through online check-in, including printing of registration badges and targeted coupon(s).

At block 307, the coupon(s) can be transmitted. In the present example, the other messenger 113 sends out the coupons.

FIG. 3B is an example targeted message 350 with a coupon. The message 350 may be based on a selected or automatically determined template, and can include the following data elements (indicated by underlined text) inserted into the template:

Exposition Data:
Exposition Name
Exposition City
Exposition Venue (Moscone Center)
Exhibitor Location at Exposition (Booth 232)

Exhibitor Data:
Exhibitor Products Offered
Exhibitor Name (Thompson Décor)
Exhibitor Product Description (exquisite . . . decorations)
Exhibitor Raffle Item (win a free iPad)

Attendee Data:
Attendee Products Desired
Attendee First Name (Mary)
Attendee Last Name (Jones)
Attendee Company Name (My Favorite Gifts)

Advantageously, the process 300 allows exhibitors to deliver, to a selected group of attendees, a specific and targeted coupon or invitation. The coupon could be delivered prior to the exposition, as part of registration, or during the exposition. Based upon data elements filtered from the exposition data 101, exhibitor data 102, and attendee data 103, a targeted coupon can be sent to an attendee inviting them to visit the exhibitor at the exposition and, as an incentive, to enter a raffle for a “giveaway.” This type of targeted coupon is difficult or impossible to create using conventional systems. In those cases, exhibitors frequently offer giveaways to attract potential customers, but there is no way for them to attract the specific customers that they really want or to limit the attendees that may want to participate.

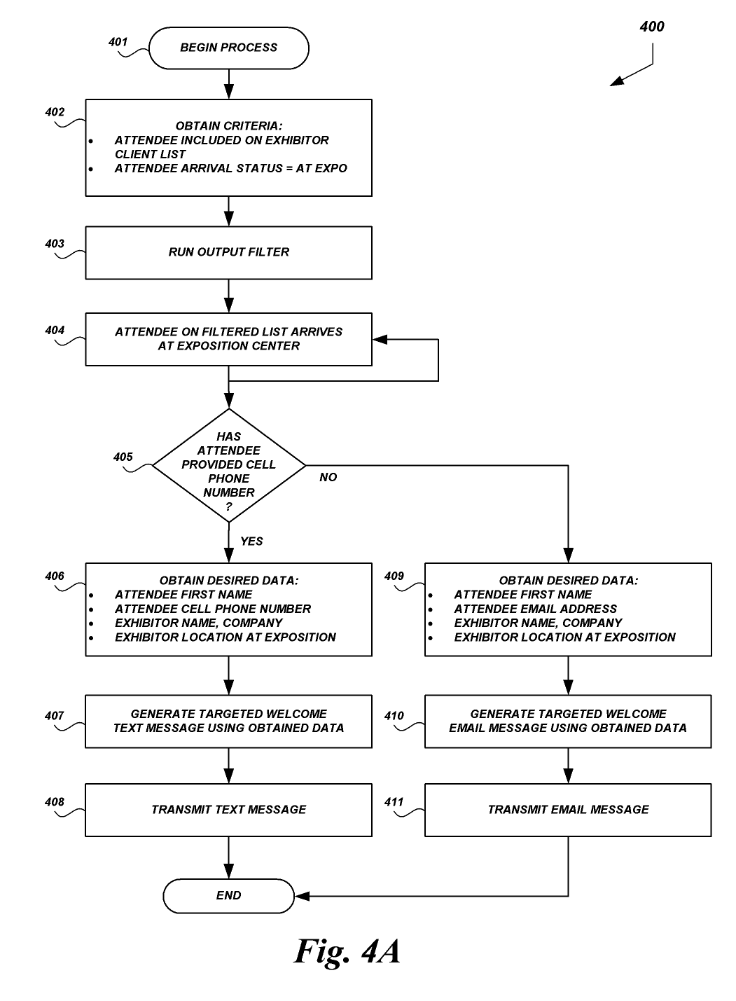

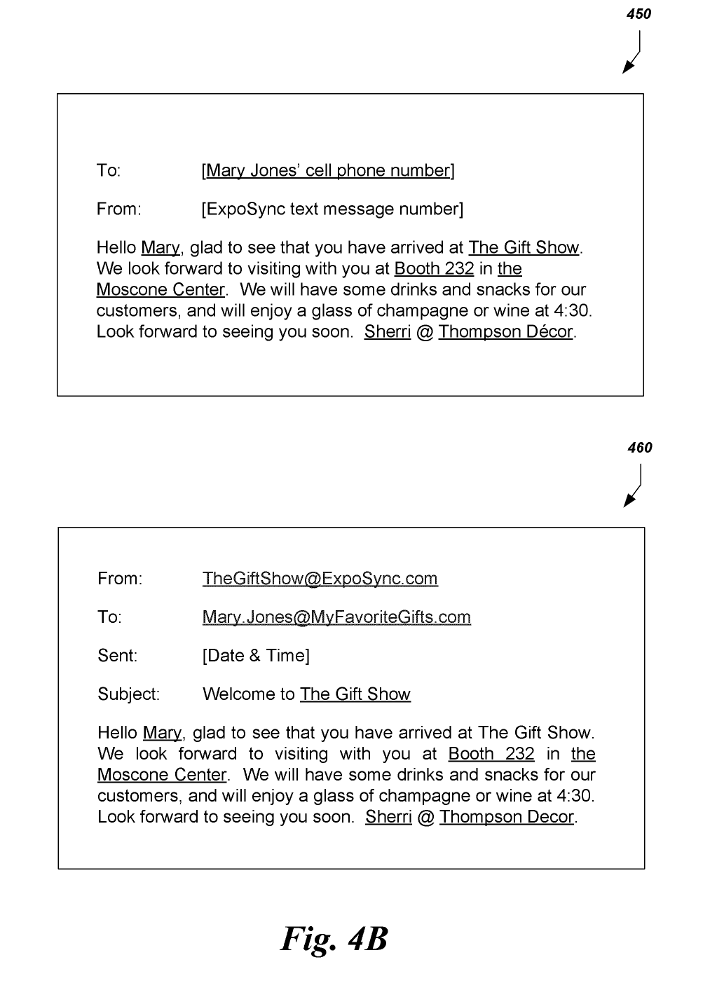

FIG. 4A presents an example process 400 for generating a targeted message (e.g., a text message or email message) to the clients of an exhibitor (e.g., attendees of the exposition with whom the exhibitor has a pre-existing relationship) when they enter the exposition. An example of a targeted text-message based message 450 is shown in FIG. 4B, and a sample of a targeted email-based message 460 is also shown in FIG. 4B. The messages invite the attendee to visit the booth of a particular exhibitor (e.g., Thompson Décor).

The process 400 begins at block 401. As with the previously-described processes, the process 400 involves searching and retrieving data from the data store 109 after the input synchronizer 108 has obtained the data from the various data sources 120. In addition, the exhibitor has previously provided a list of the clients to whom the exhibitor would like a text message sent once the clients (attendees) arrive at the exposition. To facilitate providing the message upon arrival or while the attendee is on the exposition floor, the exposition synchronization system 100 may receive real-time or substantially real-time data regarding attendees' arrivals at the exposition center as onsite data 105. In some embodiments, attendees can use entry passes or devices (e.g., name badges, entry tickets, mobile devices with specialized application software, etc.) that have barcodes, RFID tags, near-field communication (“NFC”) chips, or other information or devices that can be used to track arrivals, check-ins, movements, and the like. For example, an attendee may have a name badge with an embedded RFID device. The attendee may check in at the exposition center or be automatically detected based on the presence of the RFID. Attendee check-ins may be managed by the sponsor or some entity authorized by the sponsor, and the check-in information may be recorded and automatically provided to the exposition synchronization system 100 in real time or substantially real time. In some embodiments, the exposition synchronization system 100 may receive check-in information (onsite data 105) directly, rather than through some other entity. For example, the company which provides the services of the exposition synchronization system 100 described herein to exposition sponsors and exhibitors can also provide the attendee identification badges, manage attendee check-ins, and the like.

At block 402, an authorized user of the exposition synchronization system 100 can provide the desired search criteria in order to obtain a filtered list of attendees that meet the desired criteria. For example, the authorized user can define a filtered search for attendees who have arrived at the exposition who are also identified clients of the particular exhibitor.

At block 403, the output filter 110 can apply the criteria provided above to generate search results. In the current example, the thousands of individuals that are included in the data store 109 as attendees can be filtered down to those attendees that are (i) on the exhibitor's “client list” and (ii) physically present at the exposition center.

At block 404, the exposition synchronization system 100 can determine that an attendee on the exhibitor's client list has arrived at the exposition. Each time the exposition synchronization system 100 makes such a determination, the process can proceed to block 405. Illustratively, the determination at block 404 may be repeated as many times as needed (e.g., for each attendee on the exhibitor's client list that arrives at the exposition).

At decision block 405, the exposition synchronization system 100 can determine whether a cell phone number is available for the current attendee (e.g., the attendee that was detected as arriving above at block 404). If the cell phone number is available, the process 400 can proceed to block 406 where a text message can be prepared. Otherwise, the process 400 can proceed to block 409 where an alternative message can be prepared (e.g., an email).

At block 406, the exposition synchronization system 100 can automatically select the additional data elements that will be included in the text message. In the present example, additional data elements to be used with the text message template are (i) attendee's name, (ii) attendee's cell phone number, (iii) exhibitor special message, (iv) exhibitor's name and company and (v) exhibitor location at the exposition.

At block 407, the appropriate messaging module 111-113 can generate the targeted message(s) using the data obtained above. In the present example, the text messenger 111 incorporates the desired data into a targeted text message template.

At block 408, the message(s) can be transmitted. In the present example, the text message is an invitation to the attendee to come to the exhibitor's booth for refreshments. A sample of the invitation 450 is shown in FIG. 4B, described below.

At block 409, the exposition synchronization system 100 can automatically select the additional data elements that will be included in the email message in response to determining at decision block 405 that a cell phone number is not available for the current attendee. In the present example, additional data elements to be used with the email message template are (i) attendee's name, (ii) attendee's email address, (iii) exhibitor special message, (iv) exhibitor's name and company and (v) exhibitor location at the exposition.

At block 410, the appropriate messaging module 111-113 can generate the targeted invitation message(s) using the data obtained above. In the present example, the email messenger 112 incorporates the desired data into a targeted email message template.

At block 411, the message(s) can be transmitted. In the present example, the message is an email invitation to the attendee to come to the exhibitor's booth for refreshments. A sample of the invitation 460 is shown in FIG. 4B.

FIG. 4B shows an example text invitation 450 and email invitation 460. The messages 450 and 460 may be based on a selected or automatically determined template and include the following data elements (indicated by underlined text) inserted into the template:

Exposition Data:
Exposition Name (The Gift Show)
Exposition Venue (Moscone Center)
Exhibitor Location at Exposition (Booth 232)

Exhibitor Data:
Exhibitor Client List (includes Mary Jones)
Exhibitor First Name (Sherri)
Exhibitor Company (Thompson Décor)
Exhibitor Message

Attendee Data:
Attendee First Name (Mary)
Attendee Cell Phone Number
Attendee Email Address (Mary.Jones@MyFavoriteGifts.com)

Onsite Data:
Attendee has entered Exposition

Advantageously, the process 400 allows exhibitors to deliver such invitations 450 or 460 in a time-sensitive manner, such as immediately after an attendee arrives on the exposition floor, or at some other desired time (e.g., 30 minutes prior to the event to which the attendee is being invited). The invitation can be generated based upon data elements filtered from the exposition data 101, exhibitor data 102, attendee data 103, and onsite data 105. This type of time-sensitive, targeted invitation is difficult or impossible to create using conventional systems due to the lack of an integrated data store 109 that includes the data described above regarding attendees and their arrival at the exposition center. Conventional systems do not permit an exhibitor to communicate with desired attendees based upon their time of entry or location within an exposition.

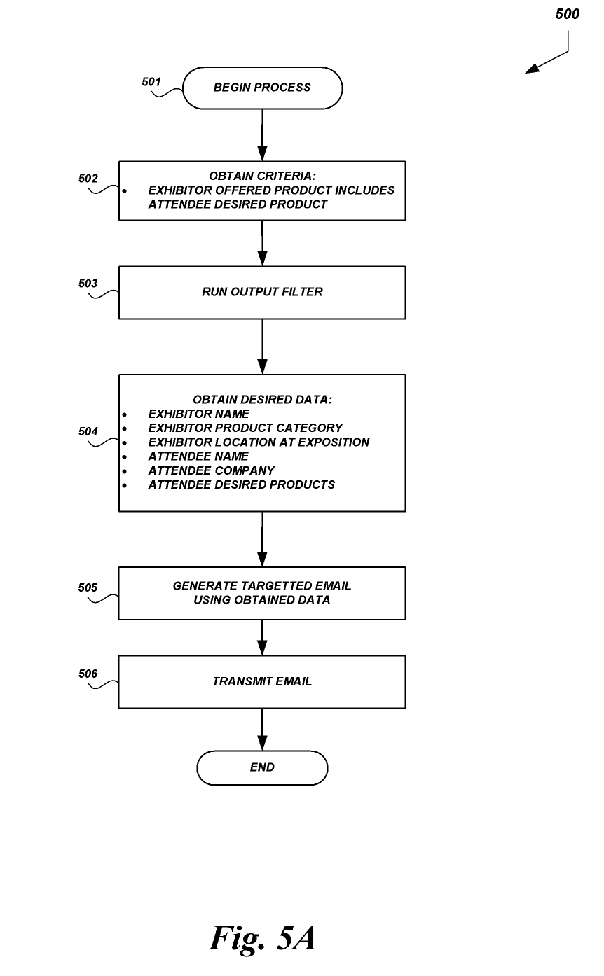

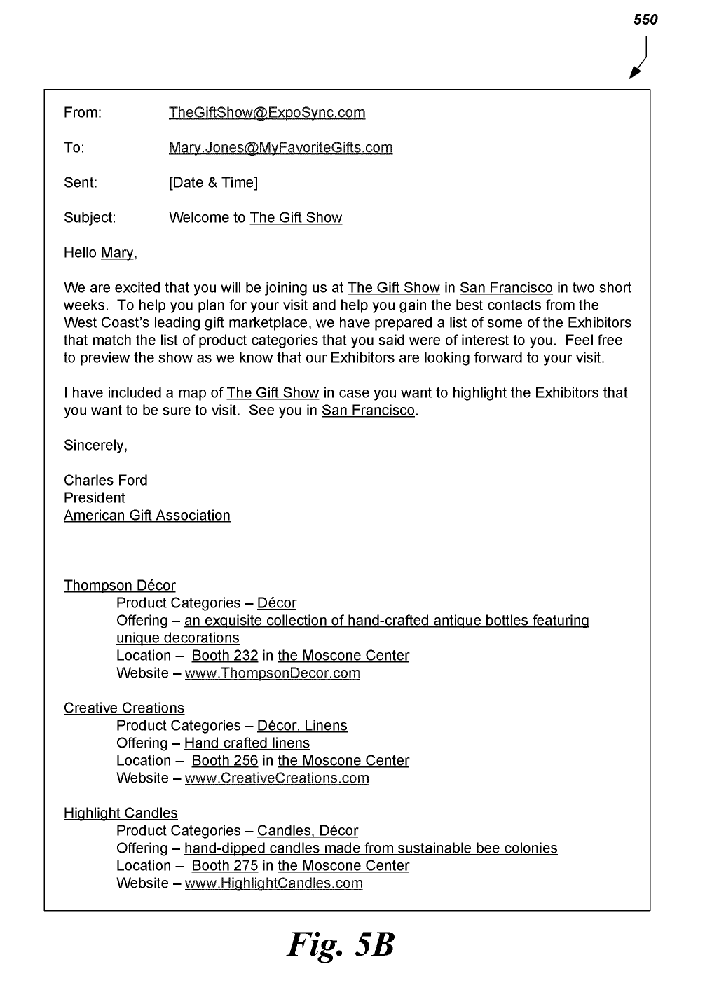

FIG. 5A presents an example process 500 for generating a targeted preview communication using various types of exposition-related data 101-107 aggregated and integrated from multiple (e.g., two or more) different data sources 120. An example of a targeted preview communication generated using the process 500 is shown in FIG. 5B. Illustratively, the targeted preview communication is a customized email to a particular attendee (e.g., Mary Jones) of an exposition (e.g., The Gift Show in San Francisco) inviting the attendee to preview the products to be offered at the exposition that match the attendee's indicated interests. In this example, the exposition synchronization system 100 has knowledge of the type of products that the attendee is interested in because the exposition synchronization system 100 has received attendee data 103 (e.g., registration information) and reply data 107 (e.g., replies to confirmation emails, questionnaires, and the like) ahead of time, as described below. Thus, the exposition synchronization system 100 can automatically perform the process 500 to generate preview messages for the exhibitors (or some subset thereof) without any further interaction required from the exhibitors.

The process 500 begins at block 501. As with the previously-described processes, the process 500 involves searching and retrieving data from the data store 109 after the input synchronizer 108 has obtained the data from the various data sources 120. In some embodiments, the exposition synchronization system 100 may receive the attendee data 103, including the attendees' indicated interests, from the sponsor or some other entity that manages registration for the exposition. In other embodiments, the entity managing registration for the exposition may not have or may not provide information regarding the attendees' indicated interests. In such cases, the exposition synchronization system 100 may request that the attendees' provide such information. For example, the exposition synchronization system 100 may send a confirmation email to individual attendees asking the attendees to confirm their personal information, contact information, lodging information, and the like. In addition, the attendees may be asked to provide information about their interests. Such information, received by the exposition synchronization system 100 as reply data 107, can be integrated into the data store 109 via the input synchronizer 108.

At block 502, an authorized user of the exposition synchronization system 100 can provide the desired search criteria in order to obtain a filtered list of matches between the attendees' desired products and the exhibitors' offered products.

At block 503, the output filter 110 can apply the criteria provided above to generate search results. In the current example, the hundreds of exhibitors that are included in the data store 109 can be filtered by the output filter 110 to identify only those exhibitors matching the products that each individual attendee indicated were of interest.

At block 504, the exposition synchronization system 100 can automatically select the additional data elements that will be included in the email message. In the present example, additional data elements to be used with the email message template are (i) exhibitor name, (ii) exhibitor product category, (iii) exhibitor product description, (iv) exhibitor location at the exposition and (v) exhibitor website.

At block 505, the appropriate messaging module 111-113 can generate the targeted message(s) using the data obtained above. In the present example, the email messenger 112 incorporates the desired data into a targeted message template.

At block 506, the message(s) can be transmitted. In the present example, the email messenger 112 sends out the emails, a sample of which is shown in FIG. 5B.

FIG. 5B is an example targeted email preview message 550. The preview message 550 may be based on a selected or automatically determined template, and includes the following data elements (indicated by underlined text) inserted into the template:

Exposition Data:
Sponsor Name (American Gift Association)
Exposition Name (The Gift Show)
Exposition City (San Francisco)
Exposition Venue (Moscone Center)
Exhibitor Location at Exposition (varies by Exhibitor)

Exhibitor Data:
Exhibitor Name (varies by Exhibitor)
Exhibitor Products Categories (varies by Exhibitor)
Exhibitor Product Description (varies by Exhibitor)
Exhibitor Website (varies by Exhibitor)

Attendee Data:
Attendee First Name (Mary)
Attendee Products Desired (décor gifts)
Attendee Email Address (Mary.Jones@MyFavoriteGifts.com)

Advantageously, the process 500 allows sponsors to facilitate the introduction of exhibitors and attendees based upon their products offered and desired. Based upon data elements filtered from the exposition data 101, exhibitor data 102, and attendee data 103, a targeted email can be sent to an attendee, allowing the attendee to preview the exhibitors offering products or services in which the attendee has indicated an interest (e.g., by providing links to the websites associated with the exhibitors). This type of targeted email is difficult or impossible to create using conventional systems. In those cases, attendees typically start their product search when they arrive that the exposition and begin the process of viewing the physical marketplace offered by the exposition. In such cases, the attendee does not have the opportunity to preview the products that are offered by the exhibitors to determine which products may be a desired fit.

In addition to providing information about exhibitors offering products or services about which the attendee has indicated an interest, the preview links described above may include tracking information that allows the exposition synchronization system 100 to track “click-throughs.” When an attendee in receipt of a preview message—such as the message 550 shown in FIG. 5B—clicks on one of the exhibitor links, the resulting request may be initially sent to the exposition synchronization system 100 or some third-party provider of tracking services. The exposition synchronization system 100 (or third-party tracking service) can then record the “click-through” and other related information, such as the identity of the attendee who clicked the link (e.g., based on an identifier included in the link). The attendee may then be automatically re-directed to the linked exhibitor's web site. By tracking “click-throughs” in this way, the exposition synchronization system 100 can generate or obtain information about the effectiveness of such preview messages. The effectiveness information can be analyzed on an aggregate basis (e.g., for an entire exposition), on an exhibitor-by-exhibitor basis, or it may be integrated with subsequent onsite data and mined for information about outcomes associated with “click-throughs” (e.g., attendees who clicked through were more or less likely to review an exhibitor's products at the exposition). In this way, the exposition synchronization system 100 can provide data-driven analytical features in addition to facilitating contacts at the exposition.

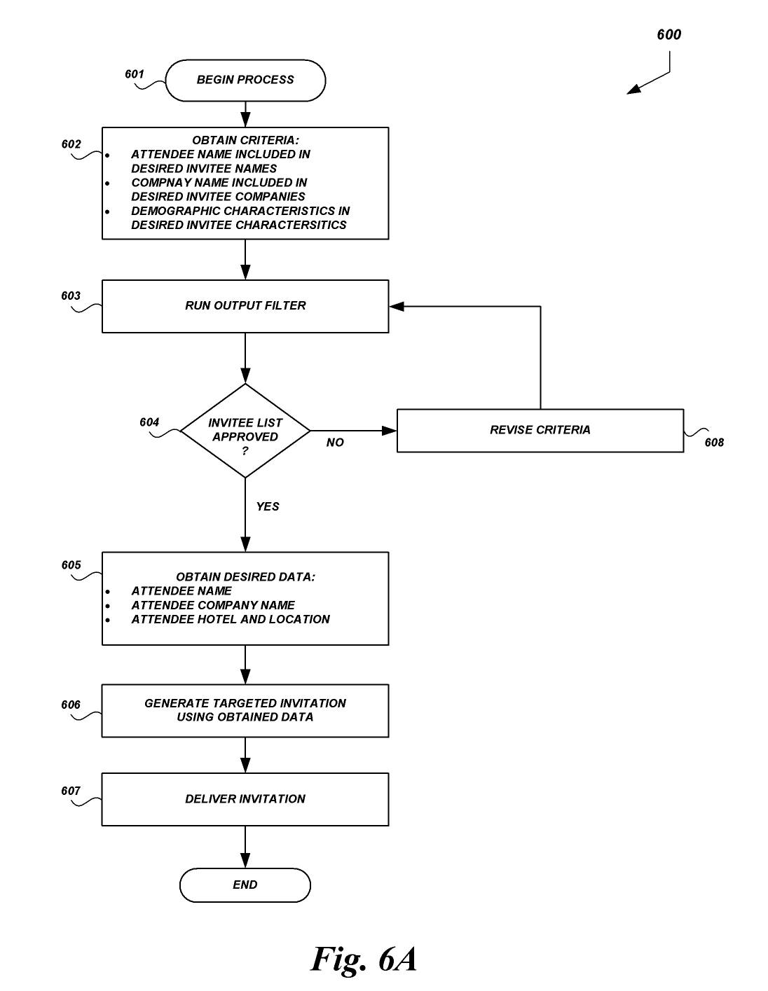

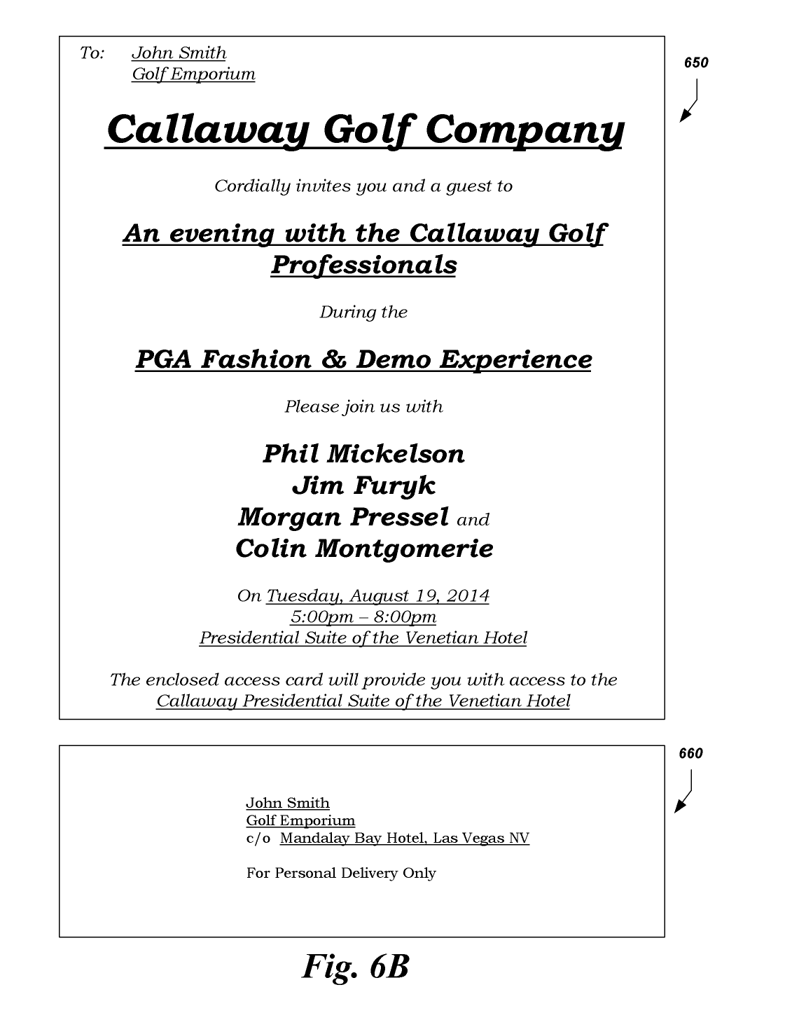

FIG. 6A presents an example process 600 to enable the planner of a special event at an exposition to select a defined invitation list, prepare a customized invitation and then have the invitation delivered to the hotel of the invited attendee. For example, an exhibitor may have an exclusive hospitality suite (or event) to which the exhibitor only wishes to invite (i) an identified list of individuals by name, (ii) individuals from identified companies, and (iii) other invitees that will be identified based upon their demographics. Once the event planner approves of the list, customized invitations would be prepared for each invitee and then delivered to the invitee's hotel at the exposition.

The process 600 begins at block 601. As with the previously-described processes, the process 600 involves searching and retrieving data from the data store 109 after the input synchronizer 108 has obtained the data from the various data sources 120.

At block 602, an authorized user of the exposition synchronization system 100 can provide the desired search criteria in order to obtain a filtered list of attendees matching one or more invitation criteria. As shown in FIG. 6A, the invitation criteria may include whether an attendee is on a list of desired attendees, whether an individual is associated with a company that is on a list of desired companies, whether an individual has a desired demographic characteristic, etc. The data regarding the invitation criteria may be provided by an event planner or some other individual. For example, the event planer can provide to the authorized system user a list of (i) individuals, by name, which may be invited, (ii) companies from which individuals may be invited, and (iii) the demographic characteristics of other desired invitees. The list may then be input into the data store 109 via the input synchronizer 108. In this way, the invitation criteria may be used to obtain a filtered list of attendees from the data store 109.

At block 603, the output filter 110 can apply the criteria provided above to generate search results. In the present example, the thousands of individuals that are included in the data store 109 can be filtered to produce an initial invitee list, based upon the selection criteria provided by the event planner.

At decision block 604, the list of invitees produced above can be approved or rejected. In the present example, the authorized user can provide the event planner with the list of invitees for approval. If the list is approved, the process 600 can proceed to step 605. Otherwise, if the list is not approved, the process can proceed to block 608 to revise the search criteria used by the output filter 110 or to otherwise narrow the list of invitees from the list produced by block 603.

At block 605, the authorized user selects the data that will be included in the special invitation. In the present example, the authorized user selects (i) the attendee first name & last name, (ii) attendee company name and (iii) attendee hotel name & city.

At block 606, the appropriate messaging module 111-113 can generate the targeted invitation(s) using the data obtained above. In the present example, the other messenger 113 incorporates the desired data into an invitation template and prints paper versions of the invitations.

At block 607, the invitation(s) can be delivered. In the present example, the printed invitations, a sample of which is shown in FIG. 6B, can be delivered to the invitees at their respective hotels.

FIG. 6B is an example targeted invitation 650 and corresponding envelope 660. The invitation 650 and envelope 660 may be based on a selected or automatically determined template, and include the following data elements (indicated by underlined text) inserted into the template:

Exposition Data:
Exposition Name (PGA Fashion & Demo Experience)
Exposition Event (An evening with the Callaway Golf Professionals)
Exposition Event Location (Callaway Presidential Suite of the Venetian Hotel)
Exposition Event Date (August 19, 2014)
Exposition Event Time (5:00 pm-8:00 pm)

Exhibitor Data:
Exhibitor Name (Callaway Golf Company)
Exhibitor Client List [provided by event planner]
Exhibitor Prospect List [provided by event planner]
Exhibitor Desired Contacts [provided by event planner]

Attendee Data:
Attendee First Name (John)
Attendee Last Name (Smith)
Attendee Company Name (Golf Emporium)

Onsite Data:
Attendee exposition entry time not blank

Housing Data:
Attendee Hotel Name & City (Mandalay Bay, Las Vegas Nev.)

Advantageously, the process 600 allows event planners to generate customized event invitations for delivery to a desired targeted set of invitees based on information provided by the event planner and/or information already present in the data store 109. Moreover, the process 600 can ensure that the invitations are delivered to the correct locations, even for some invitees who did not reserve a room in a “room block” associated with the exposition. For example, some attendees choose to stay at hotels other than the hotels with exposition-related room blocks. As another example, some attendees choose to stay at the hotels with exposition-related room blocks, but reserve the rooms on their own (e.g., outside of the room block) for various reasons. It is difficult or impossible to generate invitations and ensure delivery to the correct location using conventional systems because typically no single entity has accurate attendee demographic information, housing data and onsite data that is aggregated and accessible.

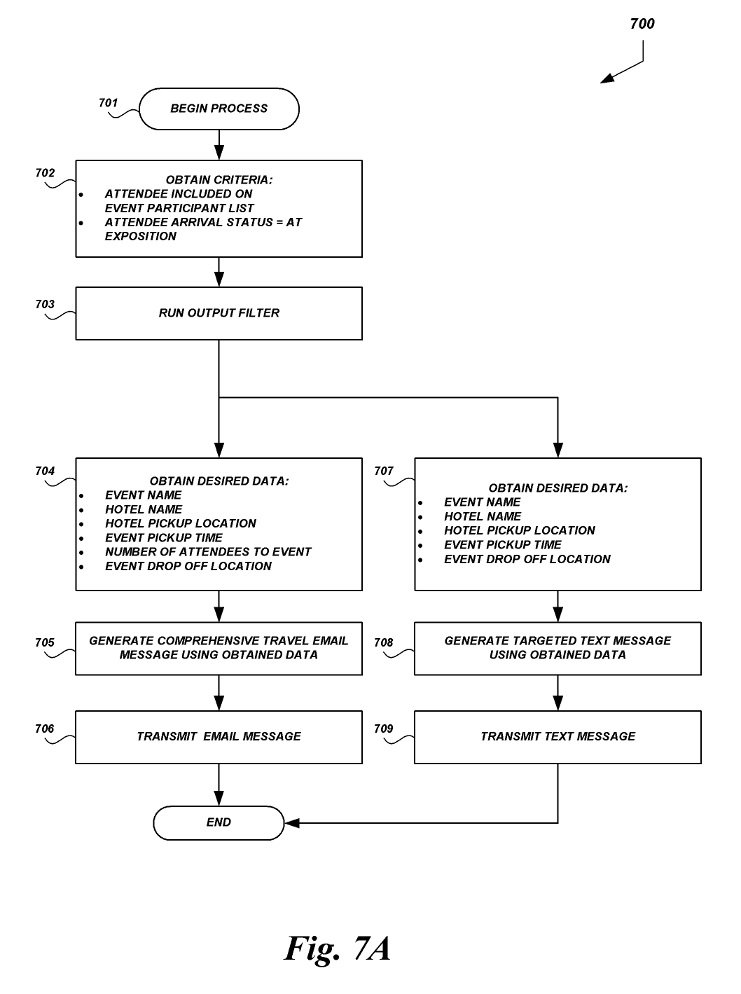

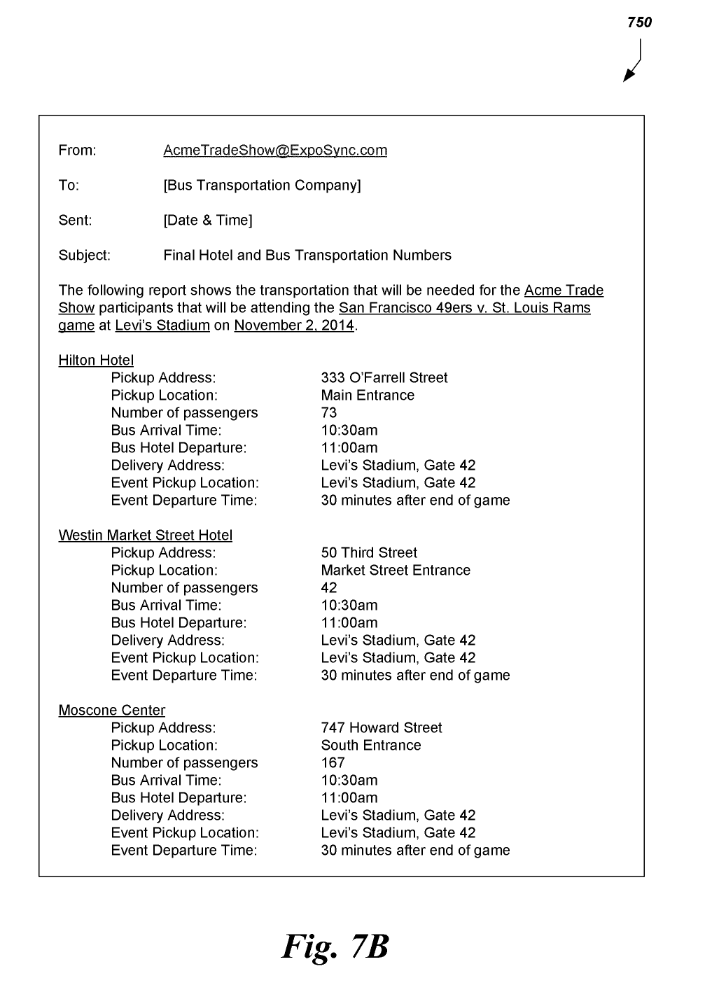

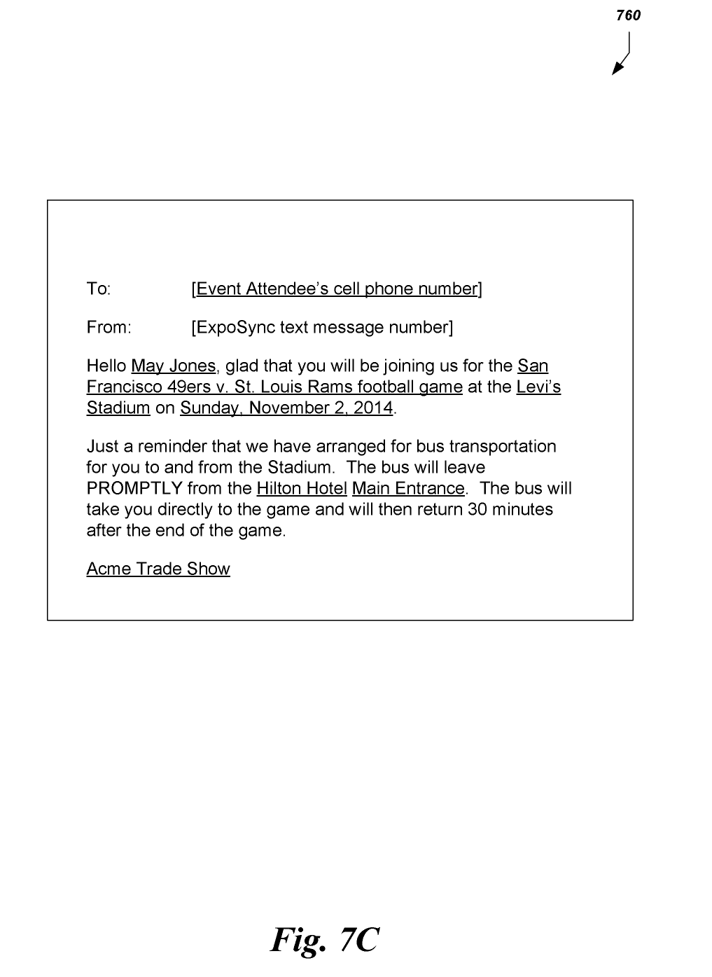

FIG. 7A presents an example process 700 to coordinate transportation for attendees to an exposition off-site event. As an example, at the “Acme Trade Show” in San Francisco attendees signed up to attend a San Francisco 49ers football game on November 2, 2014. A report can be sent to a bus transportation company, as shown in FIG. 7B, notifying them of how many attendees will be coming, from which hotels the attendees will be coming, etc. The attendees can be notified by text message, as shown in FIG. 7C, of the pick-up location and times from their hotel.

The process 700 begins at block 701. As with the previously-described processes, the process 700 involves searching and retrieving data from the data store 109 after the input synchronizer 108 has obtained the data from the various data sources 120.

At block 702, an authorized user can define a filtered search for attendees who have (i) signed up to the 49ers event and (ii) have arrived at the exposition.

At block 703, the output filter 110 can apply the criteria provided above to generate search results. In the current example, the thousands of attendees are filtered down to those attendees that have made it to the exposition and are signed up to attend the 49ers game.

At block 704, the additional data to be included in the message to the transportation company can be obtained. In the present example, information about the attendees participating in the event, the hotels at which they are staying, the pickup information associated with the respective hotels, and other information can be obtained.

At block 705, the appropriate messaging module 111-113 can generate the desired report using the data obtained above. In the present example, the other messenger 113 can calculate the number of attendees that will need to be picked up from the two main hotels for the exposition (e.g., Hilton and Westin) and all others will be picked up from the exposition center (e.g., Moscone Center). An authorized user can create the text of the email message, or a template can be automatically populated using the obtained data.

At block 706, the report can be delivered. In the present example, the email messenger 113 can deliver an email with the report to the bus transportation company.

At block 707, the additional data to be included in the messages to the attendees participating in the event can be obtained.

At block 708, the appropriate messaging module 111-113 can generate the desired messages using the data obtained above. In the present example, the text messenger 111 can generate the message using a template or message text provided to the authorized user.

At block 709, the message(s) can be delivered. In the present example, the text messenger 111 can deliver text messages, an example of which is shown in FIG. 7C, to the attendees participating in the event.

FIG. 7B is an example message 750 with a report for the transportation company. FIG. 7C is an example message 760 to an attendee providing data regarding the transportation arrangements. The messages 750 and 760 may be based on a selected or automatically determined template, and includes the following data elements:

Exposition Data:
Exposition Name (Acme Trade Show)
Exposition Venue (Moscone Center)
Exposition Event (San Francisco 49ers v. St. Louis Rams game)
Exposition Event Location (Levi's Stadium)
Exposition Event Date (November 2, 2014)
Exposition Event Time (11:00 am)

Attendee Data:
Attendee First Name (Mary)
Attendee Cell Phone Number

Housing Data:
Attendee Hotel (Hilton Hotel)

Hotel Address

Hotel Pickup Location (Main Entrance)

Onsite Data:
Attendee arrival time at Exposition

Advantageously, the process 700 allows reports, such as the report in the email message 750 shown in FIG. 7B, and messages, such as the message 760 shown in FIG. 7C, to be created using information obtained from multiple (e.g., two or more) data sources 120. Such a report would be difficult or impossible using conventional systems. Event sponsors may not know how many buses to order for each respective hotel location based on actual attendance at the exposition, resulting in either a shortage or surplus of transportation. For example, attendees staying at hotels with “room blocks” but not in one of the rooms in a room block make it difficult to determine how many attendees are staying at each hotel. In addition, a lack of available data regarding which attendees have actually arrived at the exposition make planning proper transportation challenging. By obtaining and integrating exposition data 101, attendee data 103, housing data 104, onsite data 105, and reply data 107, a more accurate report of participants and their respective hotels can be generated. In addition, the text messages generated using the exposition synchronization system 100 provide event participants with assurance that proper transportation will be provided and that they will arrive on time.

### Example Reports

Hotel room availability, price and utilization are important to a successful exposition. While the individuals attending the exposition (whether as exhibitor, attendee or support staff) need to find rooms at an attractive rate, sponsors also frequently need to demonstrate their economic impact to the host city to obtain use of convention space and to negotiate rates. Frequently, sponsors designate a third-party housing company to assist with getting a “block” of hotel rooms reserved under contract for the exposition, but experience dictates that many attendees get rooms “outside the block.” Using conventional systems, it is difficult or impossible to accurately determine whether the number of attendees staying at any particular hotel satisfies an amount required by the hotel. In addition, it is difficult or impossible to reasonably estimate the total economic impact to a host city when reliable hotel information is not available for the dates of the exposition, and any additional time spent in the city by attendees before and/or after the exposition.

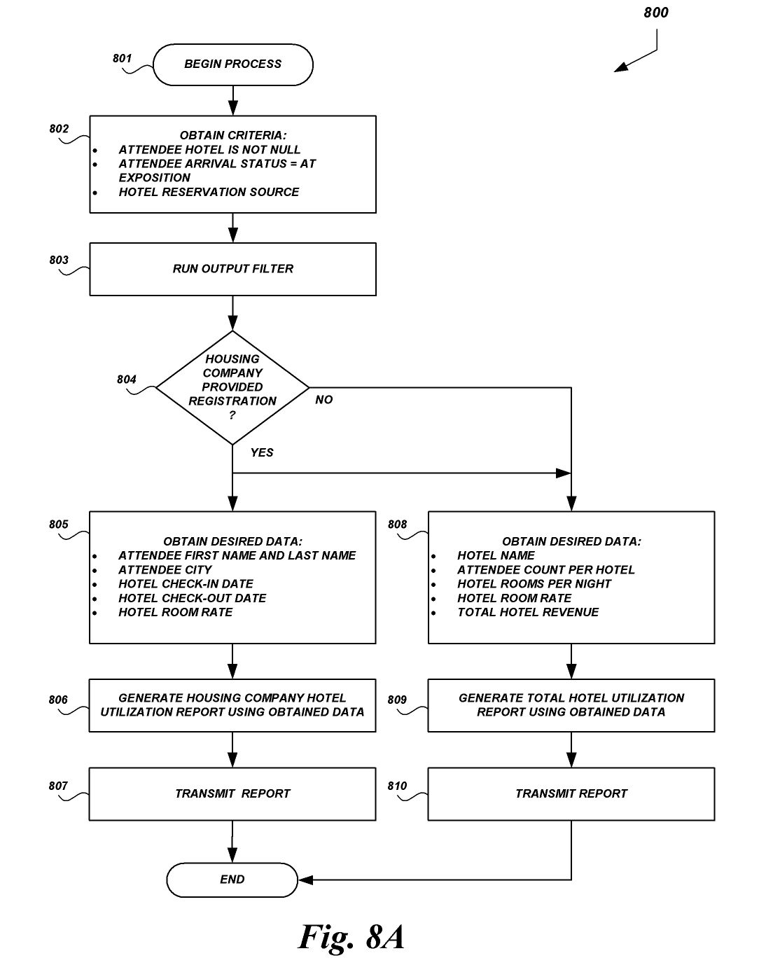

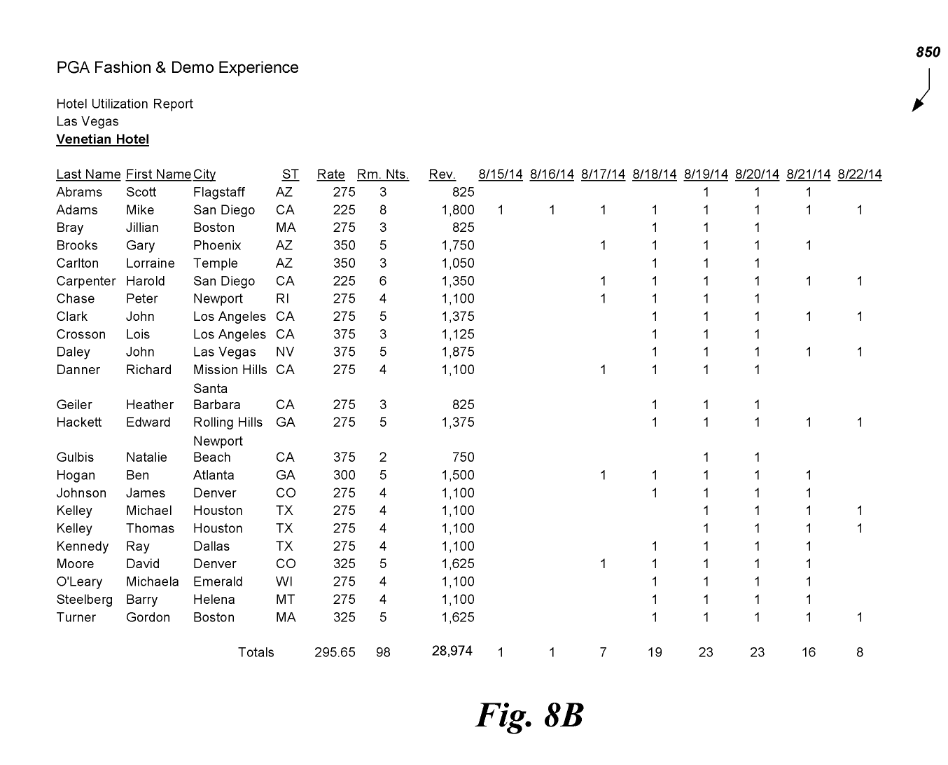

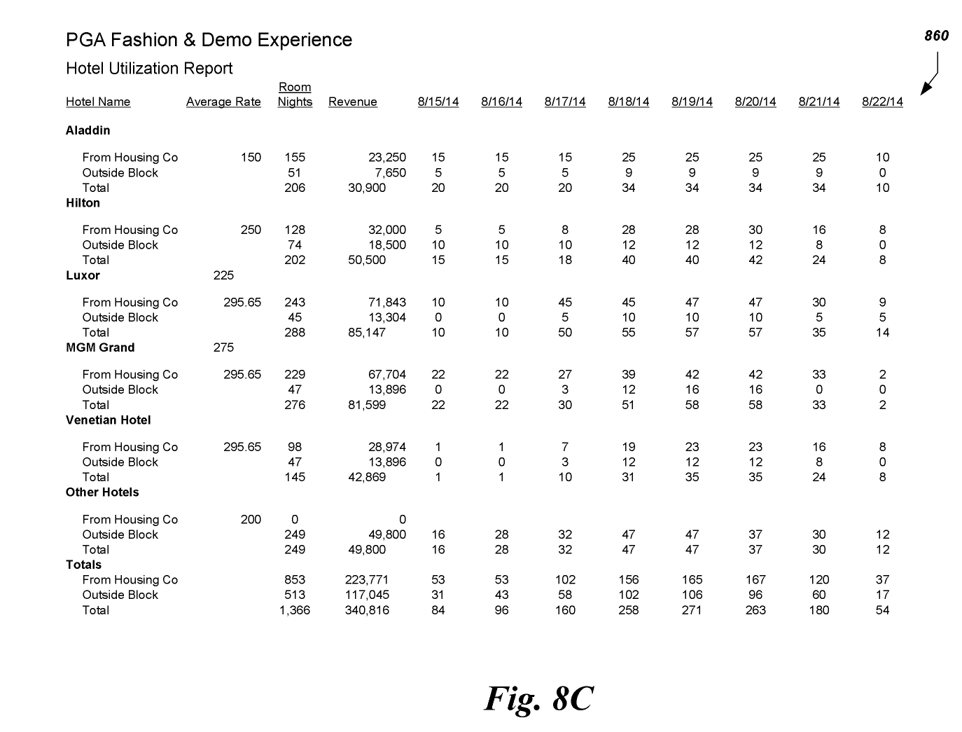

FIG. 8A provides an illustrative process 800 for generating a report for a housing company demonstrating actual room utilization, an example of which is shown in FIG. 8B, and a separate report for the exposition sponsor demonstrating total room utilization, an example of which is shown in FIG. 8C.

The process 800 begins at block 801. As with the previously-described processes, the process 800 involves searching and retrieving data from the data store 109 after the input synchronizer 108 has obtained the data from the various data sources 120.

At block 802, an authorized user can define a filtered search for individuals (exhibitors, attendees or others) who have (i) registered to attend the exposition, (ii) have indicated that they will be staying in a hotel, and (iii) have arrived at the exposition. By tracking individuals who have arrived at the exposition, this data can be used to eliminate “no shows” or late cancellations of hotel reservations.

At block 803, the output filter 110 can apply the criteria provided above to generate search results. In the current example, the thousands of individuals who are included in the data store 109 as attendees are filtered down to those individuals that meet the criteria provided above.

At decision block 804, the exposition synchronization system 100 can automatically determine, for each individual whose data was obtained from the output filter 110 above, whether the individual obtained a hotel reservation through the designated housing company. If not, the process 800 proceeds to only block 808, and the information is not used in the preparation of the hotel utilization report 850 illustrated in FIG. 8B. However, if the individual did obtain the hotel reservation through the designated housing company, the process 800 may proceed to both blocks 806 and 808, where information for that individual is used to generate each of the reports 850, 860 described below.

At block 805, the data obtained above can be loaded into the reporting module 114. In the present example, the reporting module 114 can obtain information regarding the individuals who have made a reservation through the housing company and who have checked in to the exposition.

At block, 806, the reporting module 114 can create a report that can be utilized by the housing company to verify hotel reservation utilization and commission income that is owed, a sample of which is shown in FIG. 8B and described below. Illustratively, the report can be based on housing data 104 obtained from the housing company along with onsite data 105.

At block 807, the appropriate messaging module 111-113 can transmit the report generated above to the appropriate individual at the housing company. In the present example, the email messenger 112 can automatically transmit the report generated above to the housing company. The housing company may then use the report to verify that they received proper credit and commissions from hotels for the individuals that they placed through reservations with the listed hotels.

At block 808, the data obtained above for attendees who did not register for a room through the housing company can be loaded into the reporting module 114. Illustratively, the data can include housing information 104 obtained from the housing company and also reply data 107 obtained from the individual attendees. Thus, the report generated below can be a comprehensive report including hotel information regarding attendees that have registered for rooms “in-block” and also hotel information regarding attendees who have obtained their own accommodations without going through the housing company, including attendees staying at hotels with “room blocks.” In this way, the sponsor can obtain a list of individual attendee names for use when determining compliance with “attrition clauses.” The report can also indicate the number of rooms utilized per night and room rate.

At block, 809 the reporting module 114 can create the report based on the data obtained above. FIG. 8C shows an example of the report, described in greater detail below.

At block 810, the appropriate messaging module 111-113 can transmit the report generated above to the appropriate individual at the sponsor. In the present example, the email messenger 112 can automatically transmit the report generated above to the exposition sponsor. The sponsor will be able to use this report to measure the economic impact (total hotel revenues) of the exposition to the host city as well as confirm that the sponsor has complied with hotel contracts that require a certain level of room utilization to avoid an “attrition” penalty.

FIGS. 8B and 8C show example reports 850, 860 generated as described above. The reports 850 and 860 may be based on a selected or automatically determined template, and include the following data elements:

Exposition Data:
Exposition Name (PGA Fashion & Demo Experience)
Exposition City (Las Vegas)

Attendee Data:
Attendee First Name
Attendee Last Name
Attendee City
Attendee State

Housing Data:
Hotel Name
Attendee Hotel
Attendee Check-In Date
Attendee Check-Out Date
Reservation Source
Hotel Rate

Onsite Data:
Attendee arrival time at Exposition
Attendee departure time at Exposition

Advantageously, the housing reports described above can be generated using data from multiple (e.g., two or more) different data sources 120, providing a more comprehensive view of the housing situation at an exposition than may otherwise be possible using conventional systems. For example, the report 860 shown in FIG. 8C includes data regarding attendee housing that has been provided by the housing company (e.g., via housing data 104) and also data provided by the attendees themselves (e.g., via reply data 107). Thus, the report 860 can be used to determine whether there are any discrepancies in the number of attendees staying at a particular hotel (or the total number of nights attributable to the attendees). For the first hotel on the report 860—the Aladdin—there are 155 room nights attributable to attendees who obtained reservations though the housing company, and an additional 51 room nights attributable to attendees that did not obtain a reservation through the housing company. This information can be used to determine whether exposition sponsors are required to provide additional funds to individual hotels due to excess attrition reported by the hotels. Illustratively, if the sponsor was responsible for reimbursing the Aladdin for each room night under 200 attributable to exposition attendees, the housing data provided by the housing company alone may indicate that the sponsor is responsible for reimbursement based on 45 room nights. However, as shown in the report 860 that includes information from all attendees (not only those obtaining reservations through the housing company), more than 200 room nights at the Aladdin may be attributable to exposition attendees. Using conventional systems, these types of reports were not possible. Housing companies were required to manually compare their list of reservations with each hotel's report of individuals who checked into the hotel to confirm the commissions that were due. Exposition sponsors had no way to accurately determine hotel occupancy by individuals, particularly for those individuals that did not make their reservations through the housing company.

### Additional Embodiments

The example communications and reports described above are illustrative only, and are not intended to be limiting. In some embodiments, the exposition synchronization system 100 can provide additional or alternative communications and/or reports. For example, post-exposition communications can be generated to follow-up on missed connections at the exposition, effectively extending the life of the exposition. Illustratively, emails may be generated on behalf of exhibitors to attendees who meet certain criteria (e.g., an indicated interest in the exhibitors' products, “click-throughs” from the preview emails, etc.) but who did not stop by the exhibitors' booths (e.g., as determined using onsite data 105). The emails can include personalized messages and invitations to connect in other ways (e.g., “Mary, sorry we didn't get to meet at The Gift Show. Please contact me to discuss how my products fit with your business, and get 10% off your first order.”).

As another example, emails may be generated on behalf of the sponsor to thank active attendees (e.g., attendees who visited the exposition every day or spent a threshold number of hours at the exposition, determined using onsite data 105) and/or to follow-up with inactive attendees (e.g., attendees who only visited the exposition for one day or who failed to spend a threshold number of hours at the exposition, determined using onsite data 105). Such emails may include invitations, coupons, questionnaires, incentives for response or for a return to the show in subsequent years, etc.

Other examples of the utility of the exposition synchronization system 100 include: multiple venue events (such as sports tournaments) where the system can coordinate communications to the various teams, coaches, players and spectators; targeted email banner advertisements based upon the user's demographic profile; and marketing opportunities for other third parties at an exposition (e.g., restaurants, taxis, entertainment, etc.). The data created by the system in the data store 109 may also be utilized to create analysis reports for sponsors and exhibitors.

In some embodiments, revenue can be generated by charging a fee for usage of the exposition synchronization system 100. For example, the sponsor or exhibitors may be changed a fee for each targeted communication or report (or some subset thereof) generated by the exposition synchronization system 100 using data associated with the exposition. As another example, an exhibitor may be charged a fee for each targeted communication (or some subset thereof) generated by the exposition synchronization system 100 on the exhibitor's behalf, for each “click-through” (or some subset thereof) to the exhibitor's web site, etc. The example charges described above are illustrative only, and are not intended to be limiting. As yet another example, certain reports can be sold to other interested parties (e.g., the report shown in FIG. 8B can be sold to a housing company). As a further example, data in the data store 109 regarding attendee preferences can be sold to other interested parties for targeted advertising (e.g., advertising based on the hotel at which the attendee is staying, such as advertisements for restaurants near the attendee's hotel; advertising based on the attendee's attendance at an event or plans to attend an event, such as advertisements for limousine services; etc.).

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware or as software that runs on hardware depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

For example, the processes 200, 300, 400, 500, 600, 700 and 800 described with respect to FIGS. 2A, 3A, 4A, 5A, 6A, 7A and 8A may be embodied in a set of executable program instructions stored on one or more non-transitory computer-readable media, such as one or more disk drives or solid-state memory devices, of a computing system with which the exposition synchronization system 100 is associated. When one of the processes 200-800 is initiated, the executable program instructions can be loaded into memory, such as RAM, and executed by one or more processors of the user device or computing system. In some embodiments, the computing system may include multiple computing devices, such as servers, and the processes or portions thereof may be executed by multiple servers, serially or in parallel.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1-40. (canceled)

41. A computer-implemented method for dynamically creating and transmitting personalized electronic communications to exposition attendees, the method comprising:
aggregating a plurality of data sets obtained from multiple, disparate data sources related to an exposition,
wherein at least two of the plurality of data sets are obtained from at least two separate data sources, unconnected to each other,
wherein the plurality of data sets comprise an exposition data set, an exhibitor data set, and an attendee data set,
wherein the exposition data set comprises data related to events at the exposition and data related to individual exhibitors of a plurality of exhibitors,
wherein the exhibitor data set comprises data related to individual exhibitors and attendees desired by individual exhibitors of the plurality of exhibitors,
wherein the attendee data set comprises data related to individual attendees of a plurality of attendees attending the exposition, and
wherein at least two of the plurality of data sets comprise data in different source data formats;
integrating data obtained from the multiple, disparate data sources into a single synchronized database through a synchronization process comprising:
receiving and storing the multiple, disparate data sets in a temporary storage location;
transforming data in at least one of the source data formats into a desired data format for integration into the database;
performing additional processing on at least a portion of the data converting the data to a format for integration into the database; and
importing such data to create the single synchronized database;
dynamically identifying and obtaining missing data elements through a process comprising:
determining a desired data element, associated with a first attendee of the plurality of attendees, missing from the single synchronized database;
generating and transmitting an electronic communication to an electronic address associated with the first attendee, the electronic communication prompting for the desired data element;
receiving an electronic reply comprising the desired data element; and
dynamically integrating the desired data element from the electronic reply into corresponding attendee data within the single synchronized electronic database;
automatically applying filters and search criteria to the single synchronized database to produce lists of desired attendees and data related to the desired attendees;
dynamically creating customized lists of attendees based on at least one of search criteria, scheduled times, or receipt of data;
dynamically creating personalized electronic communications to be transmitted to individual attendees of the customized lists of attendees, integrating into individual personalized electronic communications exposition-related data pertinent to a corresponding individual attendee; and
automatically transmitting personalized electronic communications incorporating exposition-related data pertinent to each corresponding individual attendee.

42. The method of claim 41, wherein generating personalized electronic communications comprises generating a personalized electronic communication to the first attendee, by at least:
listing one or more exhibitors, of the plurality of exhibitors, that match a preference of the first attendee; and
providing a communication application for the first attendee to indicate a preference, desire or interest for individual exhibitors of the plurality of exhibitors,
wherein the communication application is further configured to at least:
receive data regarding electronic viewing characteristics and preferences of the first attendee;
automatically integrate the data regarding electronic viewing characteristics and preferences of the first attendee into the single synchronized electronic database; and
dynamically update the personalized electronic communication transmitted to the first attendee of the plurality of attendees.

43. The method of claim 41, wherein transmitting personalized electronic communications comprises scheduling creation and transmission of the personalized electronic communications based on at least one of a customized list membership, a scheduled time, or fulfillment of required conditions.

44. The method of claim 41, wherein generating personalized electronic communications comprises generating a personalized email message to the first attendee based at least partly on data, related to the exposition, extracted from the single synchronized electronic database using a computer-assisted search or filter associated with the first attendee.

45. The method of claim 41, wherein generating personalized electronic communications comprises generating a personalized text message to the first attendee based at least partly on data, related to the exposition, extracted from the single synchronized electronic database using a computer-assisted search or filter associated with the first attendee.

46. The method of claim 41, wherein the data related to individual attendees of the plurality of attendees attending the exposition comprises at least one of: demographic information, preferences, event attendance, and lodging.

47. The method of claim 41, wherein performing additional processing comprises at least one of: duplicate removal, indexing, cross-referencing, calculation, generation of new data, format conversion, or standardization.

48. A system comprising one or more server computing devices, the system configured to at least:
aggregate a plurality of data sets obtained from multiple, disparate data sources related to an exposition,
wherein at least two of the plurality of data sets are obtained from at least two separate data sources, unconnected to each other,
wherein the plurality of data sets comprise an exposition data set, an exhibitor data set, and an attendee data set,
wherein the exposition data set comprises data related to events at the exposition and data related to individual exhibitors of a plurality of exhibitors,
wherein the exhibitor data set comprises data related to individual exhibitors and attendees desired by individual exhibitors of the plurality of exhibitors,
wherein the attendee data set comprises data related to individual attendees of a plurality of attendees attending the exposition, and
wherein at least two of the plurality of data sets comprise data in different source data formats;
integrate data obtained from the multiple, disparate data sources into a single synchronized database through a synchronization process comprising:
receiving and storing the multiple, disparate data sets in a temporary storage location,
transforming data in at least one of the source data formats into a desired data format for integration into the database,
performing additional processing on at least a portion of the data converting the data to a format for integration into the database, and
importing such data to create the single synchronized database;
dynamically identify and obtain missing data elements through a process comprising:
determining a desired data element, associated with a first attendee of the plurality of attendees, missing from the single synchronized database;
generating and transmitting an electronic communication to an electronic address associated with the first attendee, the electronic communication prompting for the desired data element;
receiving an electronic reply comprising the desired data element; and
dynamically integrating the desired data element from the electronic reply into corresponding attendee data within the single synchronized electronic database;
automatically apply filters and search criteria to the single synchronized database to produce lists of desired attendees and data related to the desired attendees;
dynamically create customized lists of attendees based on at least one of search criteria, scheduled times, or receipt of data;
dynamically create personalized electronic communications to be transmitted to individual attendees of the customized lists of attendees, integrating into individual personalized electronic communications exposition-related data pertinent to a corresponding individual attendee; and
automatically transmit personalized electronic communication incorporating exposition-related data pertinent to each corresponding individual attendee.

49. The system of claim 48, wherein generating personalized electronic communications comprises generating a personalized electronic communication to the first attendee, by at least:
listing one or more exhibitors, of the plurality of exhibitors, that match a preference of the first attendee; and
providing a communication application for the first attendee to indicate a preference, desire or interest for individual exhibitors of the plurality of exhibitors,
wherein the communication application is further configured to at least:
receive data regarding electronic viewing characteristics and preferences of the first attendee;
automatically integrate the data regarding electronic viewing characteristics and preferences of the first attendee into the single synchronized electronic database; and
dynamically update the personalized electronic communication transmitted to the first attendee of the plurality of attendees.

50. The system of claim 48, wherein transmitting personalized electronic communications comprises scheduling creation and transmission of the personalized electronic communications based on at least one of a customized list membership, a scheduled time, or fulfillment of required conditions.

51. The system of claim 48, wherein generating personalized electronic communications comprises generating a personalized email message to the first attendee based at least partly on data, related to the exposition, extracted from the single synchronized electronic database using a computer-assisted search or filter associated with the first attendee.

52. The system of claim 48, wherein generating personalized electronic communications comprises generating a personalized text message to the first attendee based at least partly on data, related to the exposition, extracted from the single synchronized electronic database using a computer-assisted search or filter associated with the first attendee.

53. The system of claim 48, wherein the data related to individual attendees of the plurality of attendees attending the exposition comprises at least one of: demographic information, preferences, event attendance, and lodging.

54. The system of claim 48, wherein performing additional processing comprises at least one of: duplicate removal, indexing, cross-referencing, calculation, generation of new data, format conversion, or standardization.

55. Non-transitory computer-readable storage having stored thereon executable instructions that cause a server system to perform a process comprising:
aggregating a plurality of data sets obtained from multiple, disparate data sources related to an exposition,
wherein at least two of the plurality of data sets are obtained from at least two separate data sources, unconnected to each other,
wherein the plurality of data sets comprise an exposition data set, an exhibitor data set, and an attendee data set,
wherein the exposition data set comprises data related to events at the exposition and data related to individual exhibitors of a plurality of exhibitors,
wherein the exhibitor data set comprises data related to individual exhibitors and attendees desired by individual exhibitors of the plurality of exhibitors,
wherein the attendee data set comprises data related to individual attendees of a plurality of attendees attending the exposition, and
wherein at least two of the plurality of data sets comprise data in different source data formats;
integrating data obtained from the multiple, disparate data sources into a single synchronized database through a synchronization process comprising:
receiving and storing the multiple, disparate data sets in a temporary storage location,
transforming data in at least one of the source data formats into a desired data format for integration into the database,
performing additional processing on at least a portion of the data converting the data to a format for integration into the database, and
importing such data to create the single synchronized database;
dynamically identifying and obtaining missing data elements through a process comprising:
determining a desired data element, associated with a first attendee of the plurality of attendees, missing from the single synchronized database;
generating and transmitting an electronic communication to an electronic address associated with the first attendee, the electronic communication prompting for the desired data element;
receiving an electronic reply comprising the desired data element; and
dynamically integrating the desired data element from the electronic reply into corresponding attendee data within the single synchronized electronic database;
automatically applying filters and search criteria to the single synchronized database to produce lists of desired attendees and data related to the desired attendees;
dynamically creating customized lists of attendees based on at least one of search criteria, scheduled times, or receipt of data;
dynamically creating personalized electronic communications to be transmitted to individual attendees of the customized lists of attendees, integrating into individual personalized electronic communications exposition-related data pertinent to a corresponding individual attendee; and
automatically transmitting personalized electronic communications incorporating exposition-related data pertinent to each corresponding individual attendee.

56. The non-transitory computer-readable storage of claim 55, wherein generating personalized electronic communications comprises generating a personalized electronic communication to the first attendee, by at least:
listing one or more exhibitors, of the plurality of exhibitors, that match a preference of the first attendee; and
providing a communication application for the first attendee to indicate a preference, desire or interest for individual exhibitors of the plurality of exhibitors,
wherein the communication application is further configured to at least:
receive data regarding electronic viewing characteristics and preferences of the first attendee;
automatically integrate the data regarding electronic viewing characteristics and preferences of the first attendee into the single synchronized electronic database; and
dynamically update the personalized electronic communication transmitted to the first attendee of the plurality of attendees.

57. The non-transitory computer-readable storage of claim 55, wherein transmitting personalized electronic communications comprises scheduling creation and transmission of the personalized electronic communications based on at least one of a customized list membership, a scheduled time, or fulfillment of required conditions.

58. The non-transitory computer-readable storage of claim 55, wherein generating personalized electronic communications comprises generating a personalized email message or text message to the first attendee based at least partly on data, related to the exposition, extracted from the single synchronized electronic database using a computer-assisted search or filter associated with the first attendee.

59. The non-transitory computer-readable storage of claim 55, wherein the data related to individual attendees of the plurality of attendees attending the exposition comprises at least one of: demographic information, preferences, event attendance, and lodging.

60. The non-transitory computer-readable storage of claim 55, wherein performing additional processing comprises at least one of: duplicate removal, indexing, cross-referencing, calculation, generation of new data, format conversion, or standardization.
